(19) United States
(12) Patent Application Publication
(10) Pub. No.: US 2026/0056342 A1
(43) Pub. Date: Feb. 26, 2026

(54) SYSTEMS AND METHODS FOR SEISMIC DATA CATALOGING

(71) Applicant: Schlumberger Technology Corporation, Sugar Land, TX (US)

(72) Inventors: Raghavan Vuruputoor Krishnamachari, Pune (IN); Joel Titus Jasper, Pune (IN); Kunal Sharma, Pune (IN); Sandip Sitaram Parkhi, Pune (IN); Michael Smith, Aberdeen (GB)

(21) Appl. No.: 19/304,698

(22) Filed: Aug. 20, 2025

(30) Foreign Application Priority Data
Aug. 21, 2024 (IN) 202411063195

(51) Int. Cl. G01V 1/50

(52) U.S. Cl. CPC G01V 1/50

(57) ABSTRACT

Systems and methods for seismic data cataloging are provided. A method includes: receiving first seismic data files (SDFs) in a first file format (FFF), each including a seismic display pattern, de-duplicating the first SDFs to generate second SDFs in the FFF, identifying seismic three-dimensional (3D) files in the FFF and seismic two-dimensional (2D) files in the FFF from among the second SDFs, extracting header information from each seismic 3D and 2D file, converting each seismic 3D file to a corresponding plurality of seismic files in a second file format (SFF), each including a respective seismic display pattern, generating a corresponding histogram for each respective seismic display pattern for each seismic 3D file and the plurality of seismic files in the SFF, comparing each corresponding histogram for respective corresponding pairs of files to determine whether both have a same amplitude, if not, repeating the converting, generating, and comparing.

### CROSS-REFERENCE TO RELATED APPLICATION(S)

This application claims priority to and the benefit of Indian Provisional Patent Application No. 202411063195, filed on Aug. 21, 2024, the entire disclosure of which is incorporated herein by reference for all purposes.

### TECHNICAL FIELD

This disclosure generally relates to systems and methods for seismic data cataloging.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

As exploration and production (E&P) companies drill wells, they generate and process new data and/or reprocess existing data. This often results in multiple data copies tailored to different workflows or stored in isolated, vendor-specific proprietary formats. These practices contribute to the rapid growth of data volumes. Some E&P companies now manage petabytes of data on-premises, and about 85% to 90% is typically seismic data.

Accordingly, there is a need for systems and methods for seismic data cataloging.

### SUMMARY

This disclosure pertains to systems and methods for seismic data cataloging.

A first aspect of this disclosure pertains to a method, including: receiving a first plurality of seismic data files in a first file format, each of the first plurality of seismic data files in a first file format including a respective seismic display pattern, de-duplicating the first plurality of seismic data files to generate a second plurality of seismic data files in the first file format that omits duplicate seismic data files, identifying a plurality of seismic three-dimensional (3D) files in the first file format from among the second plurality of seismic data files in the first file format, extracting header information from each of the plurality of seismic 3D files in the first file format, identifying a plurality of seismic two-dimensional (2D) files in the first file format from among the second plurality of seismic data files in the first file format, extracting header information from each of the plurality of seismic 2D files in the first file format, converting each of the plurality of seismic 3D files in the first file format to a corresponding plurality of seismic files in a second file format, each of the plurality of seismic files in the second file format including a respective seismic display pattern, generating a corresponding histogram for each respective seismic display pattern for each of the plurality of seismic 3D files in the first file format and the plurality of seismic files in the second file format, comparing each corresponding histogram for respective corresponding pairs of files among the plurality of seismic 3D files in the first file format and the plurality of seismic files in the second file format to determine whether both of each corresponding pair have a same amplitude, in response to the comparing determining that both of a given corresponding pair of files does not have a same amplitude, repeating the converting, the generating, and the comparing for the given corresponding pair of files, in response to the comparing determining that both of a given corresponding pair of files has a same amplitude, storing the corresponding pair in a database, storing the plurality of seismic 2D files in the first file format in the database, and providing a visualization of: the stored plurality of seismic 2D files in the first file format, the stored plurality of seismic 3D files in the first file format, and the stored plurality of seismic files in the second file format.

A second aspect of this disclosure pertains to the method of the first aspect, and further includes: extracting metadata from the second plurality of seismic data files in the first file format, generating a plurality of seismic manifest files from the metadata, each of the plurality of seismic manifest files corresponding to a respective data type used to describe datasets in the second plurality of seismic data files, ingesting the plurality of seismic manifest files to a cloud storage platform, and ingesting seismic bulk data from to storage tiers, the seismic bulk data including: the stored plurality of seismic 2D files in the first file format, the stored plurality of seismic 3D files in the first file format, and the stored plurality of seismic files in the second file format.

A third aspect of this disclosure pertains to the method of the first aspect, wherein the first file format is a SEGY file format.

A fourth aspect of this disclosure pertains to the method of the third aspect, and further includes, for each of the second plurality of seismic data files in the first file format: extracting an Extended Binary Coded Decimal Interchange Code (EBCDIC) header from the seismic data file, extracting a trace header from the seismic data file, programmatically extracting byte locations for inline (IL)/crossline (XL) and X/Y information from the trace header, the programmatic extracting including: identifying a first selected byte, among a plurality of bytes in the seismic data file, as corresponding to inline (IL) data, the first selected byte having a first byte number, setting the first byte number as the byte location for the IL information from the trace header for the seismic data file, identifying data in the first selected byte, corresponding to IL data, as corresponding to one of a step pattern or a saw-tooth pattern, identifying one or more second selected bytes, among the plurality of bytes in the seismic data file, as corresponding to XL data by determining that data in the one or more second selected bytes corresponds to another of the step pattern or the saw-tooth pattern that is not the one of the step pattern or the saw-tooth pattern of the data in the first selected byte, each of the one or more second selected bytes having a respective second byte number, in response to the one or more second selected bytes being a single byte among the plurality of bytes in the seismic data file corresponding to XL data, setting the second byte number of the single byte as the byte location for the XL information from the trace header for the seismic data file, and in response to there being more than one of the one or more second selected bytes: selecting one of the more than one of the one or more second selected bytes having a second byte number that is closest to the first byte number, and setting the second byte number of the selected one of the more than one of the one or more second selected bytes as byte location for the XL information from the trace header for the seismic data the file, comparing the programmatically extracted byte locations for IL/XL and X/Y information to byte locations for IL/XL and X/Y information in the EBCDIC header to find a difference between the programmatically extracted byte locations for IL/XL and X/Y information and the byte locations for IL/XL and X/Y information in the EBCDIC header, and in response to the comparing finding a difference between the programmatically extracted byte locations for IL/XL and X/Y information and the byte locations for IL/XL and X/Y information in the EBCDIC header, replacing the byte locations for IL/XL and X/Y information in the EBCDIC header with the programmatically extracted byte locations for IL/XL and X/Y information.

A fifth aspect of this disclosure pertains to the method of the fourth aspect, and further includes: identifying values in byte locations, among the plurality of bytes in the seismic data file, greater than 10⁵, identifying byte locations having a large jump in the values of particular byte locations of two adjacent traces, and comparing two bytes at a time from among the identified having the large jump in the values of particular byte locations of two adjacent traces, to determine whether: a slope of byte location values selected from the byte locations for the IL information and the XL information from the trace header for the seismic data the file are consistent, and a distance between the two byte locations of adjacent traces from the byte locations for the IL information and the XL information from the trace header for the seismic data the file are consistent.

A sixth aspect of this disclosure pertains to the method of the third aspect, and further includes, for each of the second plurality of seismic data files in the first file format: extracting an Extended Binary Coded Decimal Interchange Code (EBCDIC) header from the seismic data file, extracting a trace header from the seismic data file, programmatically extracting byte locations for inline (IL)/crossline (XL) and X/Y information from the trace header, the programmatic extracting including: for each byte in the trace header, identifying the data as corresponding to one of a pre-determined set of trace patterns, including: a machine-learning model generating a plurality of random convolutional kernels, each having a respective kernel weight, the machine-learning model convolving each of the plurality of random convolutional kernels with a series of trace data from the trace header by sliding each kernel across the series in groups, the convolving including: multiplying the respective kernel weights with corresponding series values in each group, and summing results of the multiplying for each group, the machine-learning model extracting, from the summed results for each respective kernel, a maximum value and a proportion of values that are greater than zero, the machine-learning model generating a stack by stacking the maximum value and the proportion of values that are greater than zero for each kernel, and the machine-learning model classifying, based on the stack, a pattern of the trace data in the byte as corresponding to one of the pre-determined set of trace patterns, selecting only bytes classified as having a step pattern as candidate IL bytes, selecting only bytes classified as having a saw-tooth pattern as candidate XL bytes, identifying a first selected byte, among the candidate IL bytes, as corresponding to inline (IL) data, the first selected byte having a first byte number, setting the first byte number as the byte location for the IL information from the trace header for the seismic data file, identifying one or more second selected bytes, among the candidate XL bytes, as corresponding to XL data, each of the one or more second selected bytes having a respective second byte number, in response to the one or more second selected bytes being a single byte among the plurality of bytes in the seismic data file corresponding to XL data, setting the second byte number of the single byte as the byte location for the XL information from the trace header for the seismic data file, and in response to there being more than one of the one or more second selected bytes: selecting one of the more than one of the one or more second selected bytes having a second byte number that is closest to the first byte number, and setting the second byte number of the selected one of the more than one of the one or more second selected bytes as byte location for the XL information from the trace header for the seismic data the file, comparing the programmatically extracted byte locations for IL/XL and X/Y information to byte locations for IL/XL and X/Y information in the EBCDIC header to find a difference between the programmatically extracted byte locations for IL/XL and X/Y information and the byte locations for IL/XL and X/Y information in the EBCDIC header, and in response to the comparing finding a difference between the programmatically extracted byte locations for IL/XL and X/Y information and the byte locations for IL/XL and X/Y information in the EBCDIC header, replacing the byte locations for IL/XL and X/Y information in the EBCDIC header with the programmatically extracted byte locations for IL/XL and X/Y information.

A seventh aspect of this disclosure pertains to the method of the sixth aspect, and further includes: identifying values in byte locations, among the plurality of bytes in the seismic data file, greater than 10⁵, identifying byte locations having a large jump in the values of particular byte locations of two adjacent traces, and comparing two bytes at a time from among the identified having the large jump in the values of particular byte locations of two adjacent traces, to determine whether: a slope of byte location values selected from the byte locations for the IL information and the XL information from the trace header for the seismic data the file are consistent, and a distance between the two byte locations of adjacent traces from the byte locations for the IL information and the XL information from the trace header for the seismic data the file are consistent.

An eighth aspect of this disclosure pertains to the method of the third aspect, and further includes: converting the second plurality of seismic data files in the first file format into a third plurality of seismic data files in a third file format, the converting including: metadata migration and ingestion including: extracting metadata information from the second plurality of seismic data files in the first file format, and transforming, mapping, and ingesting the metadata to corresponding data types for a cloud storage platform via an automated script, and seismic bulk data migration and ingestion including: automatically transforming the second plurality of seismic data files in the first file format into the third plurality of seismic data files in a third file format such that the third plurality of seismic data files in a third file format and the metadata information are automatically connected, and automatically ingesting the third plurality of seismic data files in a third file format in the cloud storage platform such that the third plurality of seismic data files in a third file format and the metadata information are automatically connected in the cloud storage platform, and validating the seismic bulk data migration, the validating including computing and comparing checksum values between randomly selected paired files among the second plurality of seismic data files in the first file format and the third plurality of seismic data files in a third file format.

A ninth aspect of this disclosure pertains to the method of the eighth aspect, wherein: the first file format is a SEGY file format, and the third file format is a Volume Data Store (VDS) file format.

A tenth aspect of this disclosure pertains to the method of the first aspect, wherein the second file format is a ZGY file format.

An eleventh aspect of this disclosure pertains to a system, including: one or more processors, and at least one memory including at least one non-transitory computer-readable medium storing instructions that, when executed by at least one of the one or more processors, cause the system to perform operations, the operations including: receiving a first plurality of seismic data files in a first file format, each of the first plurality of seismic data files in a first file format including a respective seismic display pattern, de-duplicating the first plurality of seismic data files to generate a second plurality of seismic data files in the first file format that omits duplicate seismic data files, identifying a plurality of seismic three-dimensional (3D) files in the first file format from among the second plurality of seismic data files in the first file format, extracting header information from each of the plurality of seismic 3D files in the first file format, identifying a plurality of seismic two-dimensional (2D) files in the first file format from among the second plurality of seismic data files in the first file format, extracting header information from each of the plurality of seismic 2D files in the first file format, converting each of the plurality of seismic 3D files in the first file format to a corresponding plurality of seismic files in a second file format, each of the plurality of seismic files in the second file format including a respective seismic display pattern, generating a corresponding histogram for each respective seismic display pattern for each of the plurality of seismic 3D files in the first file format and the plurality of seismic files in the second file format, comparing each corresponding histogram for respective corresponding pairs of files among the plurality of seismic 3D files in the first file format and the plurality of seismic files in the second file format to determine whether both of each corresponding pair have a same amplitude, in response to the comparing determining that both of a given corresponding pair of files does not have a same amplitude, repeating the converting, the generating, and the comparing for the given corresponding pair of files, in response to the comparing determining that both of a given corresponding pair of files has a same amplitude, storing the corresponding pair in a database, storing the plurality of seismic 2D files in the first file format in the database, and providing a visualization of: the stored plurality of seismic 2D files in the first file format, the stored plurality of seismic 3D files in the first file format, and the stored plurality of seismic files in the second file format.

A twelfth aspect of this disclosure pertains to the system of the eleventh aspect, wherein the instructions further include: extracting metadata from the second plurality of seismic data files in the first file format, generating a plurality of seismic manifest files from the metadata, each of the plurality of seismic manifest files corresponding to a respective data type used to describe datasets in the second plurality of seismic data files, ingesting the plurality of seismic manifest files to a cloud storage platform, and ingesting seismic bulk data from to storage tiers, the seismic bulk data including: the stored plurality of seismic 2D files in the first file format, the stored plurality of seismic 3D files in the first file format, and the stored plurality of seismic files in the second file format.

A thirteenth aspect of this disclosure pertains to the system of the twelfth aspect, wherein the first file format is a SEGY file format.

A fourteenth aspect of this disclosure pertains to the system of the thirteenth aspect, wherein the instructions further include, for each of the second plurality of seismic data files in the first file format: extracting an Extended Binary Coded Decimal Interchange Code (EBCDIC) header from the seismic data file, extracting a trace header from the seismic data file, programmatically extracting byte locations for inline (IL)/crossline (XL) and X/Y information from the trace header, the programmatic extracting including: identifying a first selected byte, among a plurality of bytes in the seismic data file, as corresponding to inline (IL) data, the first selected byte having a first byte number, setting the first byte number as the byte location for the IL information from the trace header for the seismic data file, identifying data in the first selected byte, corresponding to IL data, as corresponding to one of a step pattern or a saw-tooth pattern, identifying one or more second selected bytes, among the plurality of bytes in the seismic data file, as corresponding to XL data by determining that data in the one or more second selected bytes corresponds to another of the step pattern or the saw-tooth pattern that is not the one of the step pattern or the saw-tooth pattern of the data in the first selected byte, each of the one or more second selected bytes having a respective second byte number, in response to the one or more second selected bytes being a single byte among the plurality of bytes in the seismic data file corresponding to XL data, setting the second byte number of the single byte as the byte location for the XL information from the trace header for the seismic data file, and in response to there being more than one of the one or more second selected bytes: selecting one of the more than one of the one or more second selected bytes having a second byte number that is closest to the first byte number, and setting the second byte number of the selected one of the more than one of the one or more second selected bytes as byte location for the XL information from the trace header for the seismic data the file, comparing the programmatically extracted byte locations for IL/XL and X/Y information to byte locations for IL/XL and X/Y information in the EBCDIC header to find a difference between the programmatically extracted byte locations for IL/XL and X/Y information and the byte locations for IL/XL and X/Y information in the EBCDIC header, and in response to the comparing finding a difference between the programmatically extracted byte locations for IL/XL and X/Y information and the byte locations for IL/XL and X/Y information in the EBCDIC header, replacing the byte locations for IL/XL and X/Y information in the EBCDIC header with the programmatically extracted byte locations for IL/XL and X/Y information.

A fifteenth aspect of this disclosure pertains to the system of the fourteenth aspect, wherein the instructions further include: identifying values in byte locations, among the plurality of bytes in the seismic data file, greater than 10⁵, identifying byte locations having a large jump in the values of particular byte locations of two adjacent traces, and comparing two bytes at a time from among the identified having the large jump in the values of particular byte locations of two adjacent traces, to determine whether: a slope of byte location values selected from the byte locations for the IL information and the XL information from the trace header for the seismic data the file are consistent, and a distance between the two byte locations of adjacent traces from the byte locations for the IL information and the XL information from the trace header for the seismic data the file are consistent.

A sixteenth aspect of this disclosure pertains to the system of the thirteenth aspect, wherein the instructions further include, for each of the second plurality of seismic data files in the first file format: extracting an Extended Binary Coded Decimal Interchange Code (EBCDIC) header from the seismic data file, extracting a trace header from the seismic data file, programmatically extracting byte locations for inline (IL)/crossline (XL) and X/Y information from the trace header, the programmatic extracting including: for each byte in the trace header, identifying the data as corresponding to one of a pre-determined set of trace patterns, including: a machine-learning model generating a plurality of random convolutional kernels, each having a respective kernel weight, the machine-learning model convolving each of the plurality of random convolutional kernels with a series of trace data from the trace header by sliding each kernel across the series in groups, the convolving including: multiplying the respective kernel weights with corresponding series values in each group, and summing results of the multiplying for each group, the machine-learning model extracting, from the summed results for each respective kernel, a maximum value and a proportion of values that are greater than zero, the machine-learning model generating a stack by stacking the maximum value and the proportion of values that are greater than zero for each kernel, and the machine-learning model classifying, based on the stack, a pattern of the trace data in the byte as corresponding to one of the pre-determined set of trace patterns, selecting only bytes classified as having a step pattern as candidate IL bytes, selecting only bytes classified as having a saw-tooth pattern as candidate XL bytes, identifying a first selected byte, among the candidate IL bytes, as corresponding to inline (IL) data, the first selected byte having a first byte number, setting the first byte number as the byte location for the IL information from the trace header for the seismic data file, identifying one or more second selected bytes, among the candidate XL bytes, as corresponding to XL data, each of the one or more second selected bytes having a respective second byte number, in response to the one or more second selected bytes being a single byte among the plurality of bytes in the seismic data file corresponding to XL data, setting the second byte number of the single byte as the byte location for the XL information from the trace header for the seismic data file, and in response to there being more than one of the one or more second selected bytes: selecting one of the more than one of the one or more second selected bytes having a second byte number that is closest to the first byte number, and setting the second byte number of the selected one of the more than one of the one or more second selected bytes as byte location for the XL information from the trace header for the seismic data the file, comparing the programmatically extracted byte locations for IL/XL and X/Y information to byte locations for IL/XL and X/Y information in the EBCDIC header to find a difference between the programmatically extracted byte locations for IL/XL and X/Y information and the byte locations for IL/XL and X/Y information in the EBCDIC header, and in response to the comparing finding a difference between the programmatically extracted byte locations for IL/XL and X/Y information and the byte locations for IL/XL and X/Y information in the EBCDIC header, replacing the byte locations for IL/XL and X/Y information in the EBCDIC header with the programmatically extracted byte locations for IL/XL and X/Y information.

A seventeenth aspect of this disclosure pertains to the system of the sixteenth aspect, wherein the instructions further include: identifying values in byte locations, among the plurality of bytes in the seismic data file, greater than 10⁵, identifying byte locations having a large jump in the values of particular byte locations of two adjacent traces, and comparing two bytes at a time from among the identified having the large jump in the values of particular byte locations of two adjacent traces, to determine whether: a slope of byte location values selected from the byte locations for the IL information and the XL information from the trace header for the seismic data the file are consistent, and a distance between the two byte locations of adjacent traces from the byte locations for the IL information and the XL information from the trace header for the seismic data the file are consistent.

An eighteenth aspect of this disclosure pertains to the system of the thirteenth aspect, wherein the instructions further include: converting the second plurality of seismic data files in the first file format into a third plurality of seismic data files in a third file format, the converting including: metadata migration and ingestion including: extracting metadata information from the second plurality of seismic data files in the first file format, and transforming, mapping, and ingesting the metadata to corresponding data types for a cloud storage platform via an automated script, and seismic bulk data migration and ingestion including: automatically transforming the second plurality of seismic data files in the first file format into the third plurality of seismic data files in a third file format such that the third plurality of seismic data files in a third file format and the metadata information are automatically connected, and automatically ingesting the third plurality of seismic data files in a third file format in the cloud storage platform such that the third plurality of seismic data files in a third file format and the metadata information are automatically connected in the cloud storage platform, and validating the seismic bulk data migration, the validating including computing and comparing checksum values between randomly selected paired files among the second plurality of seismic data files in the first file format and the third plurality of seismic data files in a third file format.

A nineteenth aspect of this disclosure pertains to the system of the eighteenth aspect, wherein: the first file format is a SEGY file format, and the third file format is a Volume Data Store (VDS) file format.

A twentieth aspect of this disclosure pertains to the system of the eleventh aspect, wherein the second file format is a ZGY file format.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF DRAWINGS

To describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings.

FIGS. 1A-1D are schematic views of an oilfield.

FIG. 2 is a schematic view of an example oilfield.

FIG. 3 is a schematic view of an example oilfield.

FIG. 4 is a schematic view of an example computing system.

FIG. 5 is a schematic diagram of an example dataflow architecture.

FIG. 6 is a schematic diagram for an example seismic de-duplication workflow.

FIG. 7 is a set of graphs for example step and spike patterns for inline and crossline trace headers.

FIG. 8 is an example inline (IL) and crossline (XL) trace header extraction workflow.

FIG. 9 is an example X/Y trace header extraction workflow.

FIG. 10 is a flowchart for an example workflow.

FIG. 11 is a schematic diagram of an example file comparison workflow.

FIG. 12 is a set of diagrams showing examples of display patterns and histograms that do not match.

FIG. 13 is a schematic of an example data architecture.

FIG. 14 is a flowchart for an example workflow.

FIG. 15 is a flowchart for an example method.

FIG. 16 illustrates certain components that may be included within a computer system according to an example embodiment of the present disclosure.

Before explaining the disclosed embodiment of this disclosure in detail, it is to be understood that the invention is not limited in its application to the details of the particular arrangement shown, as the invention is capable of other embodiments. Example embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While the subject disclosure applies to embodiments in many different forms, specific embodiments are shown in the drawings and will be described in detail herein with the understanding that the present disclosure is an example of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention. In the description of the drawings, like reference numerals refer to like elements.

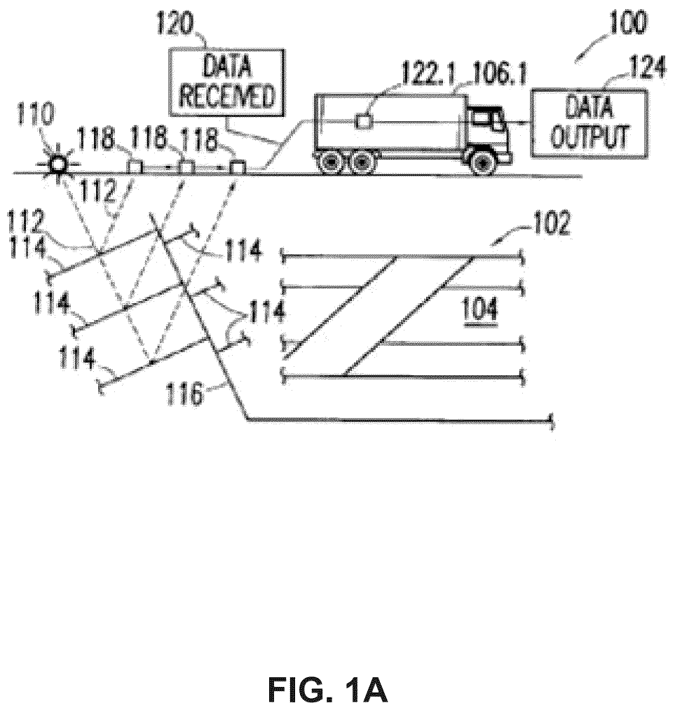

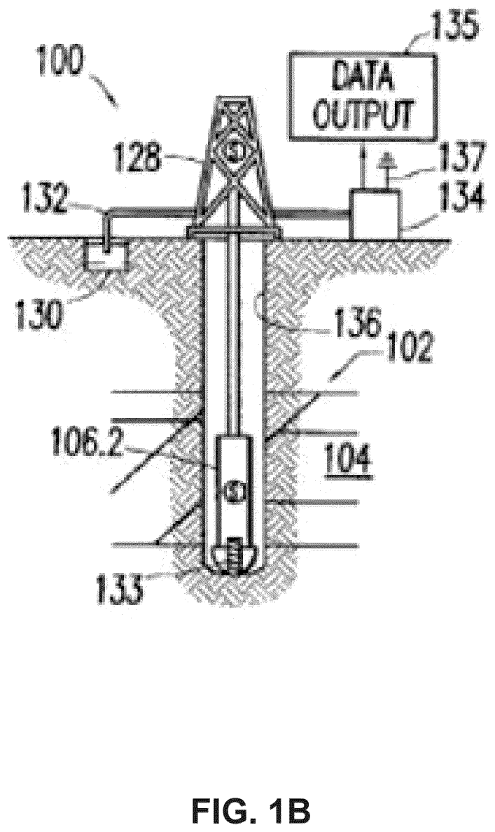

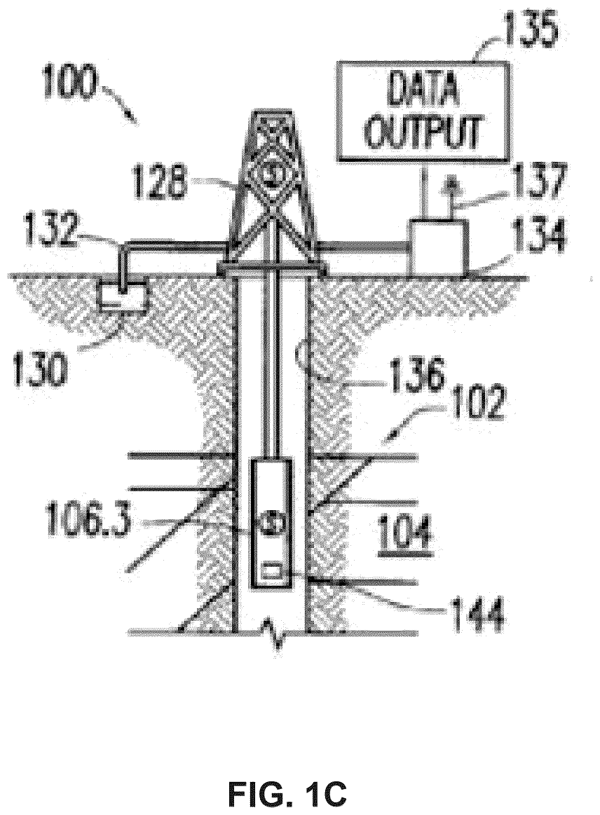

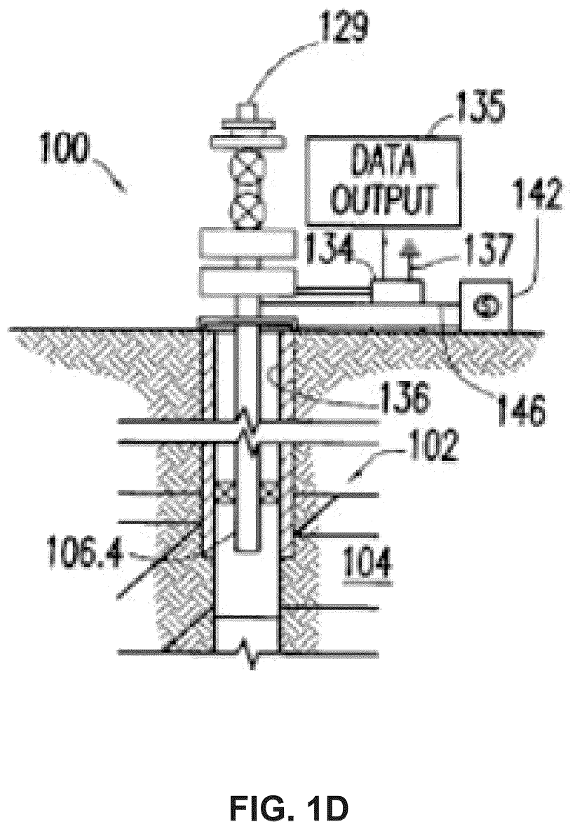

FIGS. 1A-1D are schematic views of an oilfield.

FIGS. 1A-1D illustrate simplified, schematic views of an example oilfield 100 having subterranean formation 102 containing reservoir 104 therein in accordance with implementations of various technologies and techniques described herein.

FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors(S), such as gauges, may be positioned about oilfield 100 to collect data relating to various oilfield operations as described previously. As shown, sensor(S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors(S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals and to receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories, and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors(S) may be collected by surface unit 134 and/or other data collection sources for analysis or other processing. The data collected by sensors(S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors(S), such as gauges, may be positioned about oilfield 100 to collect data relating to various field operations as described previously. As shown, sensor S is positioned in wireline tool 106.3 to measure downhole parameters which relate to, for example porosity, permeability, fluid composition, and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors(S), such as gauges, may be positioned about oilfield 100 to collect data relating to various field operations as described previously. As shown, the sensor(S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors(S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water, and/or sea. Also, while a single field measured at a single location is depicted, oilfield applications may be utilized with any combination of one or more oilfields, one or more processing facilities and one or more wellsites.

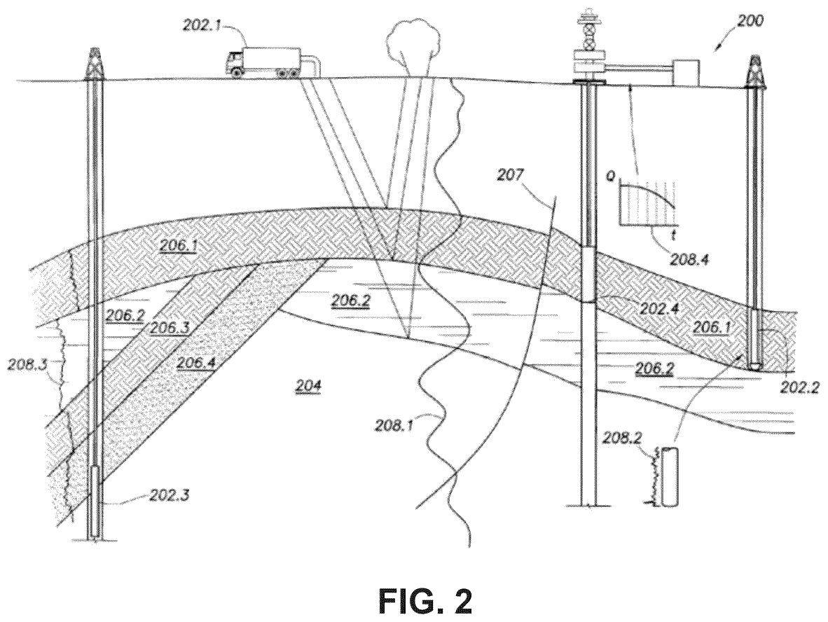

FIG. 2 is a schematic view of an example oilfield.

FIG. 2 illustrates a schematic view, partially in cross-section, of an example oilfield 200 having data acquisition tools 202.1, 202.2, 202.3, and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and/or viscosity may be performed on the fluids in the core at varying pressures and temperatures. Static data plot 208.3 is a logging trace that may provide a resistivity or other measurement of the formation at various depths.

A production decline curve or graph 208.4 is a dynamic data plot of the fluid flow rate over time. The production decline curve may provide the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean formation 204 has a plurality of geological formations 206.1-206.4. As shown, this structure has several formations or layers, including a shale layer 206.1, a carbonate layer 206.2, a shale layer 206.3, and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Seismic data displayed in static data plot 208.1 from data acquisition tool 202.1 may be used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

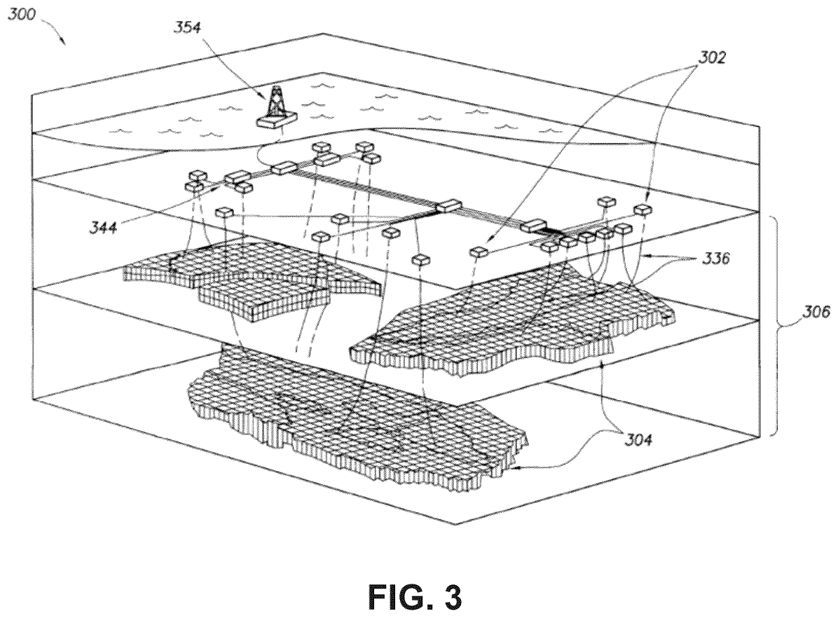

FIG. 3 is a schematic view of an example oilfield.

FIG. 3 illustrates an example oilfield 300 for performing production operations in accordance with implementations of various technologies and techniques described herein. As shown, the oilfield has a plurality of wellsites 302 operatively connected to central processing facility 354. The oilfield configuration of FIG. 3 is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

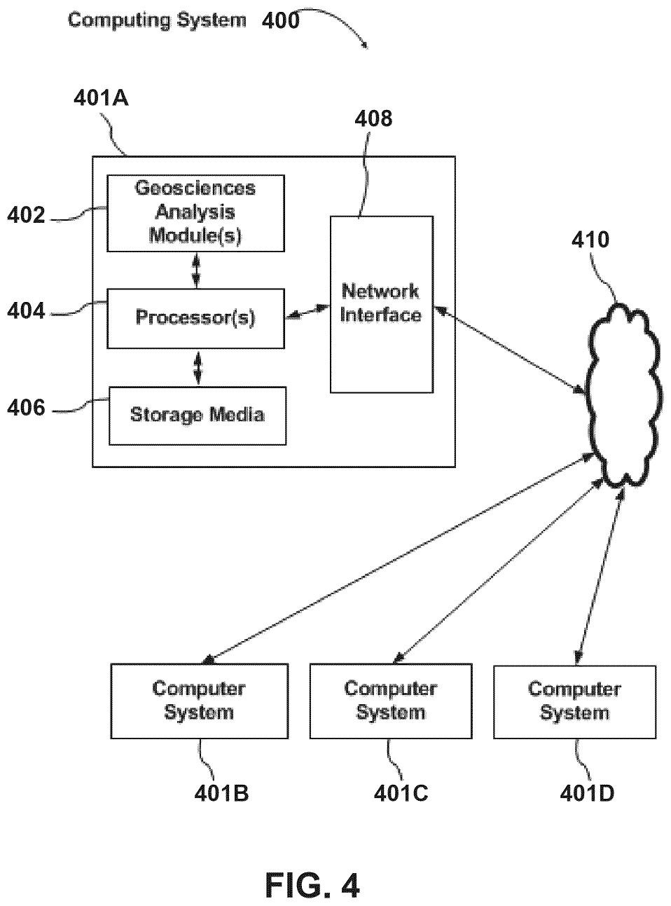

FIG. 4 is a schematic view of an example computing system.

FIG. 4 depicts an example computing system 400 in accordance with some embodiments. The computing system 400 can be an individual computer system 401A or an arrangement of distributed computer systems. The computer system 401A includes one or more geosciences analysis modules 402 that are configured to perform various tasks according to some embodiments, such as one or more methods disclosed herein. To perform these various tasks, geosciences analysis module 402 executes independently, or in coordination with, one or more processors 404, which is (or are) connected to one or more storage media 406. The processor(s) 404 is (or are) also connected to a network interface 408 to allow the computer system 401A to communicate over a data network 410 with one or more additional computer systems and/or computing systems, such as 401B, 401C, and/or 401D (note that computer systems 401B, 401C, and/or 401D may or may not share the same architecture as computer system 401A, and may be located in different physical locations, e.g., computer systems 401A and 401B may be on a ship underway on the ocean, while in communication with one or more computer systems such as 401C and/or 401D that are located in one or more data centers on shore, other ships, and/or located in varying countries on different continents). Note that data network 410 may be a private network, it may use portions of public networks, it may include remote storage and/or applications processing capabilities (e.g., cloud computing).

A processor can include a microprocessor, microcontroller, processor module or subsystem, programmable integrated circuit, programmable gate array, or another control or computing device. The term “processor” may refer to a single processor or may include multiple processors and/or sub-processors.

The storage media 406 can be implemented as one or more computer-readable or machine-readable storage media. Note that while in the example embodiment of FIG. 4 storage media 406 is depicted as within computer system 401A, in some embodiments, storage media 406 may be distributed within and/or across multiple internal and/or external enclosures of computing system 401A and/or additional computing systems. Storage media 406 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, and removable disks; other magnetic media including tape; optical media such as compact disks (CDs) or digital video disks (DVDs), BluRays or any other type of optical media; or other types of storage devices. Note that the instructions discussed above can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computer system 401A is one example of a computing system, and that computer system 401A may have more or fewer components than shown, may combine additional components not depicted in the example embodiment of FIG. 4, and/or computer system 401A may have a different configuration or arrangement of the components depicted in FIG. 4. The various components shown in FIG. 4 may be implemented in hardware, software, or a combination of both, hardware and software, including one or more signal processing and/or application specific integrated circuits.

It should also be appreciated that while no user input/output peripherals are illustrated with respect to computer systems 401A, 401B, 401C, and 401D, many embodiments of computing system 400 include computer systems with keyboards, mice, touch screens, displays, etc. Some computer systems in use in computing system 400 may be desktop workstations, laptops, tablet computers, smartphones, server computers, etc.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection.

Attention is now directed to methods, techniques, and workflows for planning, forecasting, and/or optimizing production related systems (e.g., model selections, reservoir maps, wells, etc.) in accordance with some embodiments. Some operations in the processing procedures, methods, techniques, and workflows disclosed herein may be combined and/or the order of some operations may be changed. Those with skill in the art will recognize that in the geosciences and/or other multi-dimensional data processing disciplines, various interpretations, sets of assumptions, and/or domain models such as velocity models, may be refined in an iterative fashion; this concept is applicable to the procedures, methods, techniques, and workflows as discussed herein. This iterative refinement can include use of feedback loops executed on an algorithmic basis, such as at a computing device (e.g., computing system 400, FIG. 4), and/or through manual control by a user who may make determinations regarding whether a given step, operation, action, template, or model has become sufficiently accurate.

“Data is the new oil”. As exploration and production (E&P) companies drill more wells, they acquire and process new data or reprocess their old data. They have multiple copies of the data for different workflows or have data in silos in different vendor specific proprietary formats etc., All these factors make data volumes grow. Some E&P companies have petabytes of data in on-premises (“on-prem”) and cloud (private/public) environments, typically around 85 to 90% of this data volume includes seismic datasets.

Because of the benefits offered by certain cloud-based solutions, e.g., the Open Subsurface Data Universe (OSDU), many E&P companies are moving to cloud-based storage, e.g., “the cloud.” However, if all the seismic data were to be ingested into cloud solutions, the cost implication would be huge. To address this challenge Microsoft came up with a solution called AZURE® Tiers (e.g., Hot, Cool, Cold, and Archive Tiers). Example embodiments of a seismic cataloging solution may complement the different Tier support.

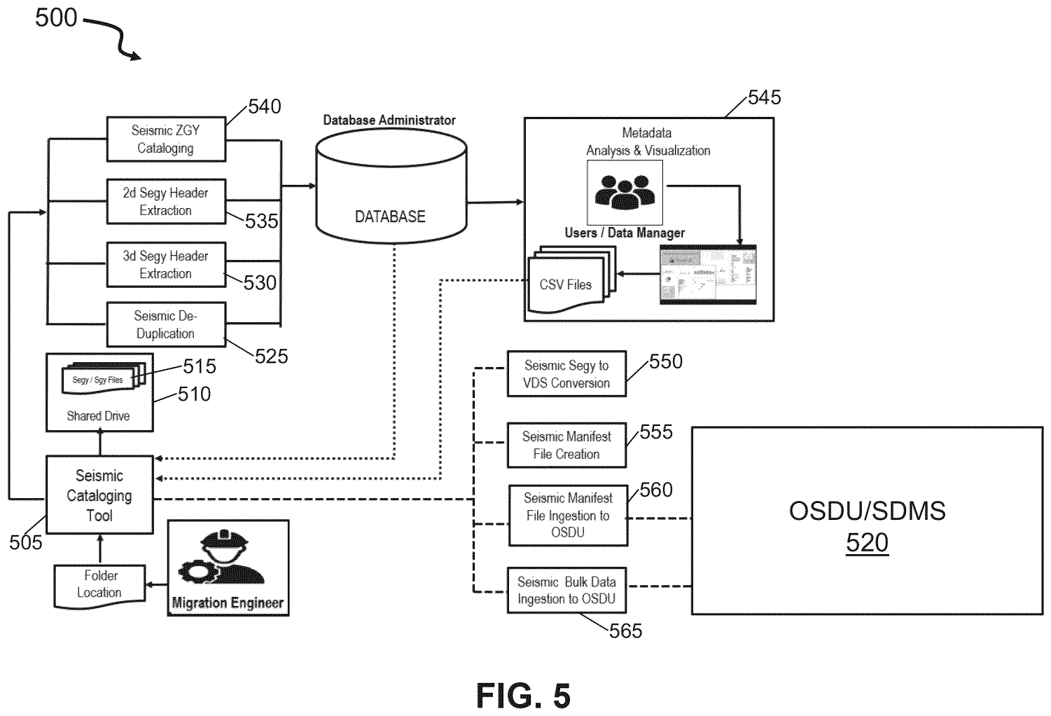

FIG. 5 is a schematic diagram of an example dataflow architecture.

An example dataflow architecture diagram 500 is as given below in FIG. 5. A seismic cataloging tool 505 may crawl through the folder/sub-folders of one or more storage and/or shared drives 510, may look for seismic data files 515, which may be in a seismic data format, e.g., SEGY, Segy, Sgy, or SEG-Y (the terms may be used interchangeably), or other relevant file formats/types, and may extract the metadata and create the manifest files that may be used for automatic ingestion of both manifest and bulk data to a cloud storage platform, e.g., OSDU, and/or a seismic data management service (SDMS) 520.

The Seismic Cataloging tool may have multiple unique and innovative features and tools, which may include:
A. Seismic De-duplication (525);
B. Seismic Three-dimensional (“3D” or “3d”) SEGY Header Extraction (530);
C. Seismic Two-dimensional (“2D” or “2d”) SEGY Header Extraction (535);
D. Seismic ZGY Cataloging (540);
E. Seismic Metadata Analysis and Visualization (545);
F. Seismic SEGY to VDS conversion (550);
G. Seismic Manifest File Creation (555);
H. Seismic Manifest file ingestion to OSDU (560); and
I. Seismic Bulk data (SEGY/VDS) ingestion to Storage Tiers (565).

### 1—Seismic De-Duplication

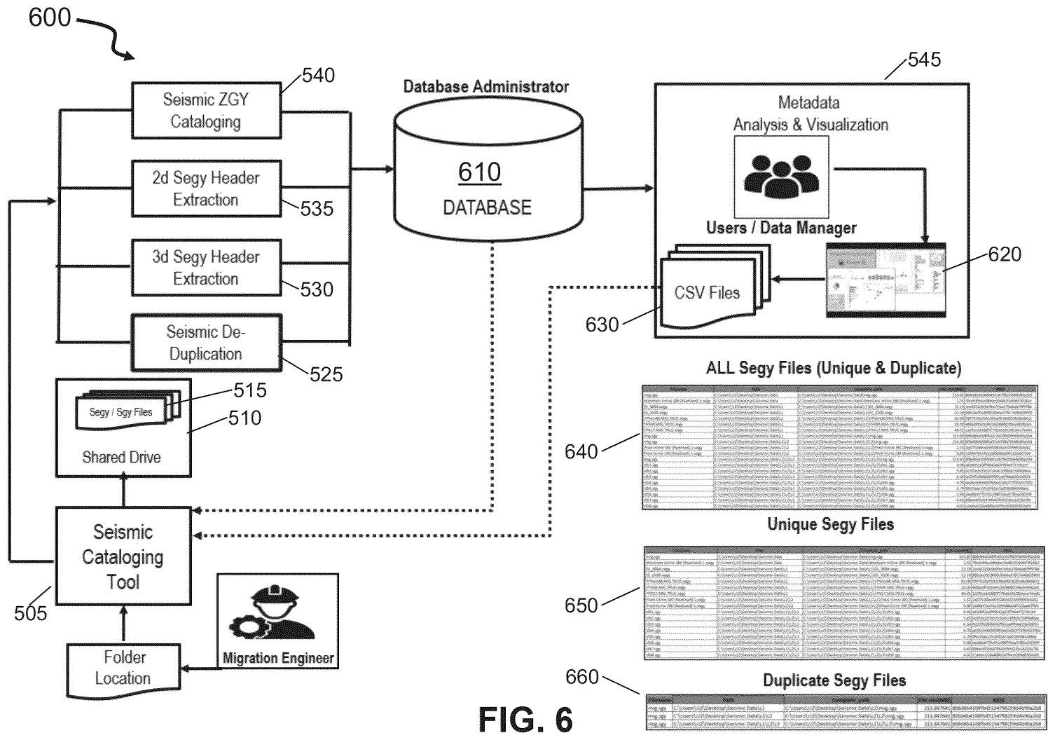

FIG. 6 is a schematic diagram for an example seismic de-duplication workflow.

FIG. 6 shows an example seismic de-duplication workflow 600. Some features of the seismic de-duplication workflow 600 that repeat features from the example dataflow architecture diagram 500 of FIG. 5 are omitted for convenience. In the example seismic de-duplication workflow 600, a seismic cataloging tool, e.g., the seismic cataloging tool 505 of FIG. 5, may crawl through the given folders and sub-folders and look for seismic files, e.g., in SEGY formats or other file formats. The tool 505 may capture the metadata information at the file level, such as full path, name, date, size, checksum, etc. In one example, based on the checksum values, the tool 505 may automatically classify the SEGY files as being unique or being a duplicate. The extracted metadata at the file level may be pushed to a database 610 (e.g., POSTGRESQL® database (DB)). Different data views may be created, which can be visualized in one or more interfaces 620, e.g., dashboards, e.g., POWER BI® dashboards. The SEGY files that are identified as being duplicates may be de-duplicated, for example, based on the business logic, such as identifying a latest create date, such that only one copy remains. The unique and de-duplicated SEGY files may be exported to files 630, e.g., comma-separated value (CSV) files, from the one or more interfaces 620, which may become an input for the next phase(s) (e.g., Seismic 2D/3D SEGY Header Extraction 530, 535) of the tool. FIG. 6 shows an example of a process in which unique and/or duplicate SEGY files may be identified. In the illustrated FIG. 6 example, a first table 640 lists all SEGY files, both unique and duplicate; a second table 650 lists the SEGY files that have been identified as unique; and the third table 660 lists the SEGY files that have been identified as having duplicates, but in a de-duplicated format, e.g., only one copy of the duplicated file is listed. Thus, de-duplication allows example embodiments to reduce the total amount of data to be stored in a cataloged database.

The four basic steps 525, 530, 535, 540 described above may then be involved in consolidating these measurements into a conclusive completion decision, followed by conducting a sensitivity analysis of the inputs, and passing the resultant outputs through a reservoir model to simulate various completion designs. This process may ensure a thorough examination of the data, facilitating the selection of the most suitable completion strategy.

### 2—Seismic 3D SEGY Header Extraction

The list of unique and de-duplicated seismic SEGY files (or other file types) may be the input for this feature. The tool 530 may perform following tasks during the Seismic 3D SEGY Header Extraction phase:
A. EBCDIC Header Extraction: The tool may extract a header, e.g., an Extended Binary Coded Decimal Interchange Code (EBCDIC) header, of each SEGY file, and may save that in a text (TXT) file. In one example, all of the headers, e.g., EBCDIC headers, from the SEGY files may be saved with the same base filename as the SEGY file to a separate folder.
B. Extraction from EBCDIC Header: The tool may extract information, such as survey name, byte location for inline (IL)/crossline (XL) data, X/Y boundary data, Coordinate Reference System (CRS) information, processing type, if present in the header, e.g., EBCDIC header. In one example, all of the extracted information may be saved to a database, e.g., a POSTGRESQL® DB.
C. Binary Header Extraction: The tool may extract information, such as a number of samples, a sampling interval, a sample format, trace length, start and end times, etc., from the headers, e.g., binary headers. In one example, all of the extracted information may be saved to a database, e.g., a POSTGRESQL® DB.
D. Trace Header Extraction: Often, the EBCDIC header may be empty, may not describe all the expected information, or the information given in the EBCDIC header could be incorrect. To address this problem, a novel approach is implemented to extract (and replace) the data from trace headers. This approach is unique and new to the industry. Details of the approach used to extract the trace headers information is given below.
E. In cases in which the EBCDIC header is blank, using a novel approach, from the trace headers, the tool may programmatically extract (and possibly replace) the byte locations for IL/XL and/or X/Y information. For example, a full replacement may be performed in a case in which the information given in the EBCDIC header is incorrect. In a case in which the EBCDIC header is blank, the tool may programmatically extract the information from the trace header. Details of the extraction process are given below.
F. In cases in which the EBCDIC header includes descriptions of byte locations for IL/XL and has XY values, the tool may cross-check the byte location values from the trace header, and may cross-check whether the byte locations mentioned in the EBCDIC header are correct or incorrect (or find a difference). In cases in which the byte locations are incorrectly mentioned in (or incomplete or missing from) the EBCDIC header, the tool may programmatically extract the correct byte locations for IL/XL and X/Y values.
G. The tool may extract the count of the number of traces. The tool may also extract minimum and/or maximum IL/XL, X/Y, and amplitude values.
H. The tool may compute and/or derive the four (4) corners of 3D Bin Gird IL/XL and X/Y values from the SEGY trace headers.
I. The tool may classify the SEGY files as containing 3D or 2D seismic data.

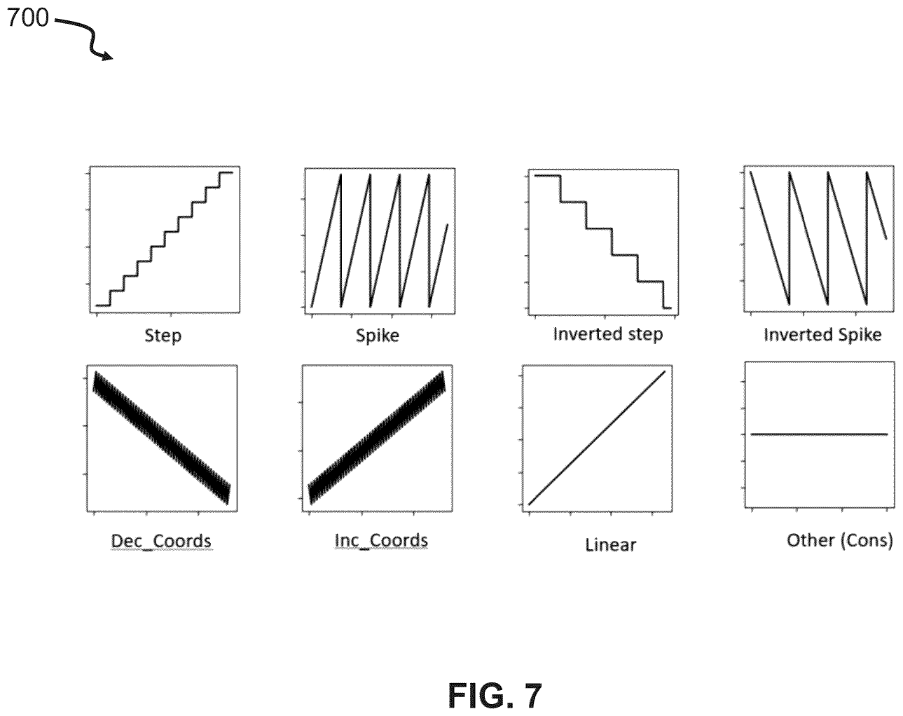

As mentioned above, the tool 530 may extract relevant information from all three headers of SEGY files, e.g., EBCDIC, binary, and trace headers. The tool 530 may create a CSV file for 3D SEGY with the information extracted from the SEGY headers, and may save it to a database, e.g., POSTGRESQL®. Extraction of metadata from the SEGY headers may be done through a unique approach, which is detailed below. For IL/XL, the byte locations from the trace headers may be analyzed, and the byte locations that form step or saw-tooth (or sawtooth) patterns may be identified based on the slopes. A step column may be identified when the slope is zero, and a saw-tooth pattern may be identified by a non-zero slope. Different Step (IL)/Spike (XL) options, such as those shown in FIG. 7, may be considered for identifying the byte locations programmatically and automatically.

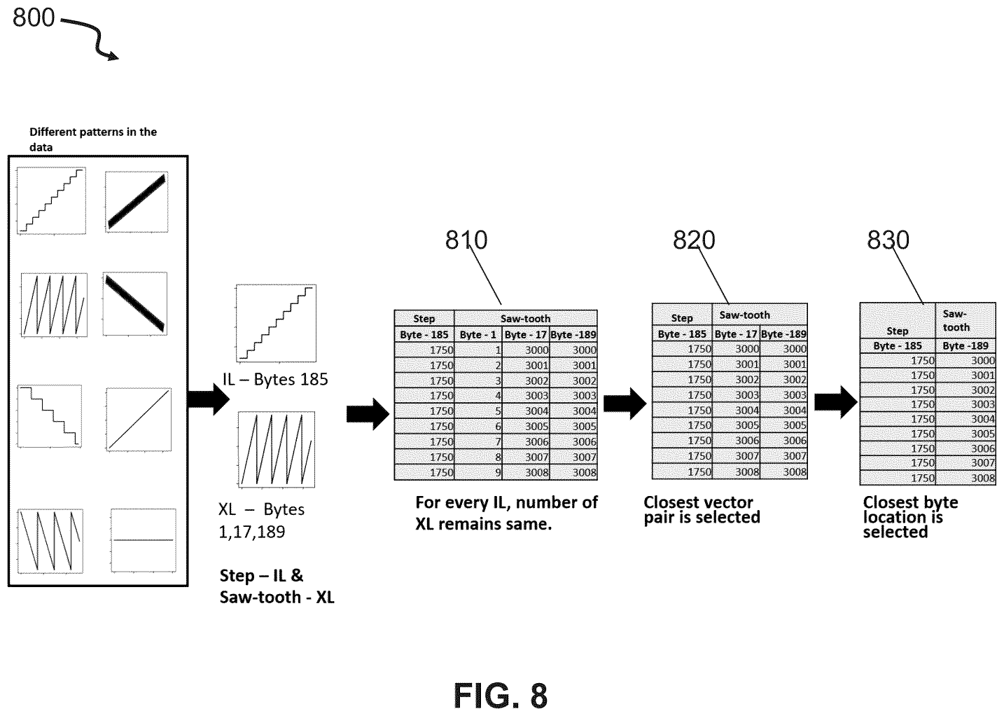

FIG. 7 is a set of graphs for example step and spike patterns for inline and crossline trace headers. FIG. 8 is an example inline (IL) and crossline (XL) trace header extraction workflow.

In FIG. 7, some examples of graphs 700 from inline and crossline trace headers include step, spike, inverted step, inverted spike, decreasing coordinates (“Dec_Coords”), increasing coordinates (“Inc_Coords”), linear, and constant (“Other” or “Cons”). IL and XL may be identified, based on the logic as given below and as shown in the example inline (IL) and crossline (XL) trace header extraction workflow 800 in FIG. 8. Bytes classified as having a step pattern may be selected as candidate IL bytes. Bytes classified as having a saw-tooth pattern may be selected as candidate XL bytes. A subset of volumes may be considered, and IL and XL may be identified only when the below conditions are met:
A. For every IL, the number of XL remains the same. (See table 810.)
B. For each IL case, if multiple XL values satisfy the condition of constant non-zero slope value, then the closest vector pair is considered. For example, if the IL byte location is “5” with values of {1750, 1751, 1752, 1753, . . . }, and the tool (e.g., 530) identifies two XL byte locations with constant non-zero slope value: a byte location “17” with values of {3000, 3001, 3002, 3003, . . . } and a byte location “1” with values of {1, 2, 3, . . . }, then the tool selects the closest vector pairs e.g., “17” in this example because {3000, 3001, 3002, 3003, . . . } is closer than {1, 2, 3, . . . } to the IL byte values of {1750, 1751, 1752, 1753, . . . }) and selects byte locations “5” and “17” as the byte locations for IL and XL, respectively. (See table 820.)
C. For each IL case, if multiple XL values satisfy the condition of constant non-zero slope value and the values of the multiple byte locations are the same, then the closest byte location is considered. For example, if the IL byte location is “185” with values of {1750, 1751, 1752, 1753, . . . }, and the tool (e.g., 530) identifies two XL byte locations with constant non-zero slope value byte location: a byte location “17” with values of {3000, 3001, 3002, 3003, . . . } and a byte location “189” with values of {3000, 3001, 3002, 3003, . . . }, then the tool selects the closest byte location (e.g., “189” in this example because that number is closer than “17” to the IL byte location of “185”) for XL, and thus selects byte locations “185” and “189” as the byte location for IL and XL, respectively. (See table 830.)

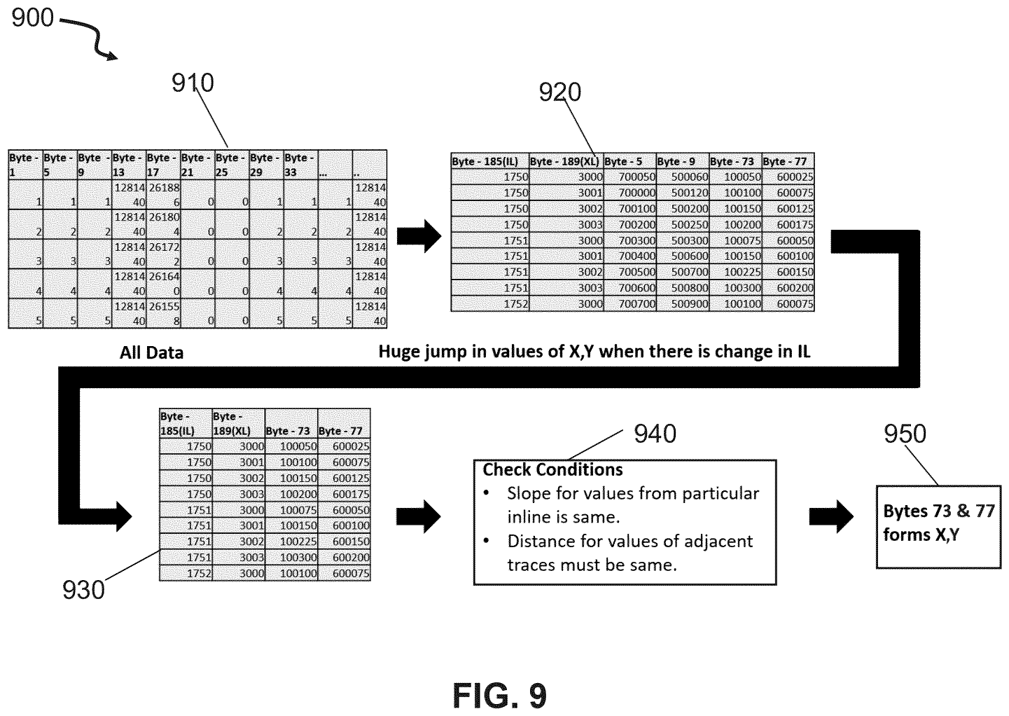

FIG. 9 is an example X/Y trace header extraction workflow.

X/Y byte locations may be identified, based on the logic as given below and as shown in the example X/Y trace header extraction workflow 900 in FIG. 9. For identifying the X/Y byte locations from the trace header, the following logic may be implemented:
A. Look for values in the byte locations among all data (e.g., table 910) where the values are greater than 10⁵. For example, in table 920 of FIG. 9, byte locations 5, 9, 73, and 77 have values greater than 10^{5.}
B. Look for the byte locations where there is a huge jump in the values of particular byte locations of two adjacent traces, which may be due to a change in IL/XL. For example, in table 920 of FIG. 9, byte locations 5, 9, 73, and 77 have a huge jump in the values of particular byte locations of two adjacent traces.
C. Byte locations of the trace headers that satisfy above conditions are gathered together, values from two (2) byte locations of different traces from a particular IL/XL are considered at a time and analyzed as below (see table 930 and block 940):
   i. A slope of those byte location values selected from a particular inline/crossline should be consistent.
   ii. A distance between those 2 byte locations of adjacent traces from a particular inline/crossline should be consistent.
D. Byte locations that satisfy above conditions are tagged as X/Y. (See block 950).

### 3—Seismic 2D SEGY Header Extraction

The list of unique and de-duplicated seismic SEGY files may be the input for this feature. The tool 535 may performs the following tasks during Header Extraction phase:
A. EBCDIC Header Extraction: The tool may extract a header, e.g., an EBCDIC header, of each SEGY file, and may save that in a TXT file. In one example, all of the headers, e.g., EBCDIC headers, from the SEGY files may be saved with the same base file name as the SEGY file to a separate folder.
B. Extraction from EBCDIC Header: The tool may extract information, such as line name, survey name, byte location for Shot Point (SP)/Common Depth Point (CDP), X/Y, CRS information, processing type, if present in the EBCDIC header. In one example, all of the extracted information may be saved to a CSV file and a database, e.g., a POSTGRESQL® DB.
C. Binary Header Extraction: The tool may extract information, such as number of samples, sampling interval, trace length etc. from the Binary Headers. In one example, all of the extracted information may be saved to a CSV file and in PostgreSQL DB.
D. Trace Header Extraction: Often, the EBCDIC header may be empty, may not include all the expected information, or the information given in the EBCDIC header could be incorrect. To address this problem, a novel approach is implemented to extract the data from trace headers. This approach is unique and new to the industry. Details of the approach used to extract the trace headers information is given below.
E. In cases in which the EBCDIC header is empty, using a novel approach, from the trace headers, the tool may programmatically extract the byte locations for SP/CDP and X/Y. Details of the approach are given below.
F. In cases in which the EBCDIC header has byte locations for SP/CDP and X/Y, the tool may cross-check the byte location values from the trace header, and may cross-check whether the byte locations mentioned in the EBCDIC header are correct or incorrect. In cases in which the byte locations are incorrectly mentioned in the EBCDIC header, the tool may programmatically extract the correct byte locations for SP/CDP and X/Y values.
G. The tool may extract the count of the number of traces. The tool may also extract minimum and/or maximum SP/CDP, X/Y, and amplitude values.
H. The tool may extract the SP/CDP and X/Y values from each trace for each SEGY files, and may create a navigation file for each SEGY file.
I. The tool may classify the SEGY files as containing 3D or 2D seismic data.

As mentioned above, the tool 535 may extract relevant information from all three headers of SEGY files, e.g., EBCDIC, binary, and trace headers. The tool 535 may create a CSV file for 2D SEGY with the above information extracted from the SEGY headers. Extraction of metadata from the SEGY headers may be done through a unique approach, which is detailed below. SP and CDP may be identified based on the logic as given below. A subset of traces may be considered from the middle of the SEGY file. A presumption may be made that, for every value of SP, the count of distinct values of CDP will be constant. For example:
1SP/1CDPs à count is 1;
1SP/2CDPs à count is 2;
1SP/3CDPs à count is 3;
1SP/4CDPs à count is 4.

### For SP Byte Positions:

When the value at certain byte location changes for every trace, every second trace, every third trace, or every fourth trace, these columns may be considered for SP.
If a standard position, such as “17”, is present, it is considered as the SP, else the first value that satisfies the above condition is considered.

### For CDP Byte Positions:

Values of CDP are unique (without repetition), hence columns that satisfy this condition may be considered.
If a standard position, such as “21”, is present, it is considered as the CDP, else the first value that satisfies the above condition is considered.

SP/CDP may be identified only when the below conditions are met.
A. Look for byte locations of the traces where the values are unique or changing every trace, every second trace, every third trace, or every fourth trace.
B. The tool collates all these byte locations that satisfy the above conditions, the standard byte locations of SP/CDP may be given the priority for the checks.
C. The byte locations that satisfy the above conditions form a SP/CDP pair.

For identifying the X/Y byte locations from the trace header, the following logic may be implemented:
A. Byte positions with constant values or scaled values are removed. Look for values in the byte locations where the values are greater than 10⁵.
B. Byte locations of the trace headers that satisfy the above conditions are gathered together, values from two (2) byte locations of adjacent traces may be considered at a time and analyzed as below:
   i. Distance between those 2 byte locations of adjacent traces should be consistent (or equal).
   ii. Distance computation is performed on multiple such adjacent trace locations to make sure that the distance is consistent.
C. Byte locations that satisfy above conditions are tagged as X/Y. If the conditions are not satisfied, all possible combination pairs of X/Y byte positions may be considered and evaluated for the above conditions, and whichever pair satisfies them forms an X/Y pair. If multiple pairs satisfy the conditions, then the one pair for which the difference between byte positions of X/Y are least may be considered as the final X/Y pair.

### 4—ZGY Files Cataloging

The 3D Seismic SEGY data may be loaded to a subsurface workflow software system (e.g., PETREL®) project and realized in a seismic file format, e.g., a ZGY file. The ZGY files may be stored in a memory, database, and/or other data storage, e.g., a shared storage. The Seismic SEGY files that are used for ZGY realization may also be saved in the shared storage. The process defined below may be used to identify which SEGY files are used for realization of ZGY, which may allow for an informed decision to be made as to whether to ingest only SEGY, ZGY, or both types in a data management system or service, such as a seismic data management system or seismic data management service (SDMS).

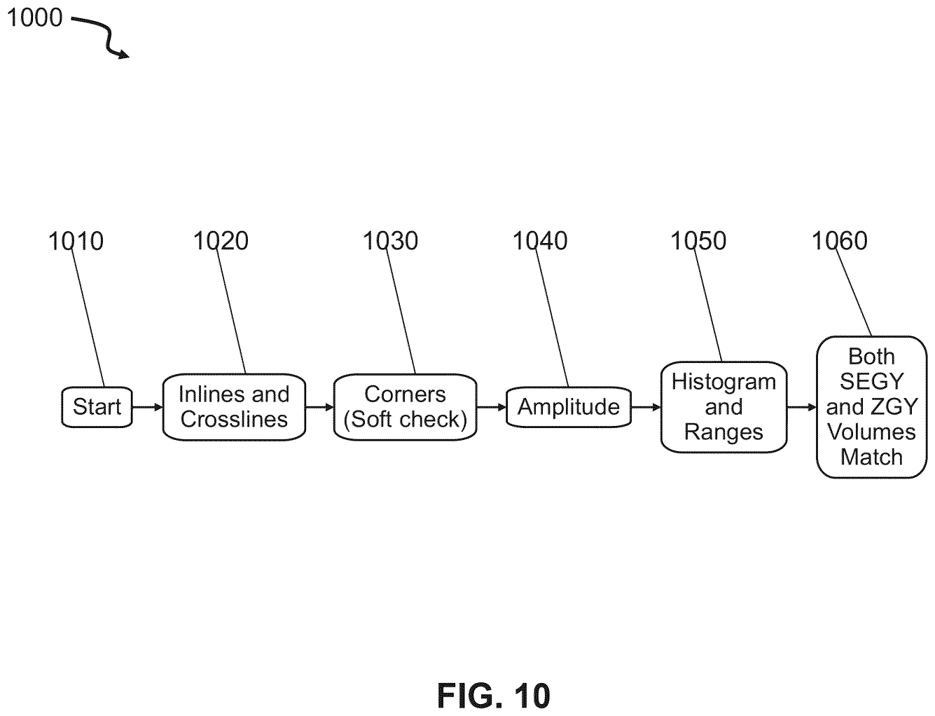

FIG. 10 is a flowchart for an example workflow.

FIG. 10 shows an example workflow 1000. The example workflow 1000 may start at block 1010. Further operations in the example workflow 1000 may be described as follows:
A. Extraction of IL/XL Minimum/Maximum (“Min/Max”) (e.g., identifying the four (4) corners of the x-direction and y-direction of the dataset) values from both SEGY and ZGY. (Block 1020.) The Min/Max inline and crossline values may be compared, and a count may be made of the inline and crossline values.
B. Extraction of Z-range (e.g., range of data in the z-direction) of datasets from both SEGY and ZGY. (Block 1020.) The Min/Max z-values may be compared, and a count may be made of the z-values.
C. Extraction of X/Y-range (e.g., identifying the four (4) corners of the x-direction and y-direction of the dataset) from both SEGY and ZGY. (Block 1030.) This may be considered a “soft check.” The X/Y values of the 4 corners may be compared. If the CRS are different, they will not match.
D. Compare IL/XL (e.g., 4 corners), Z-range, and X/Y-range (e.g., 4 corners) extracted from both SEGY and ZGY files. (Block 1040.) It may be presumed that the CRS of both SEGY and ZGY are same because of the previous check at block 1030. The example workflow 800 may compute and compare the minimum and maximum values of the cube, e.g., x-, y-, and z-directions of the seismic data representing a 3D volume of a geological formation. If the ZGY volumes are scaled volumes, then the match/comparison will fail, e.g., the values for the size of the cube would not be the same between the SEGY and ZGY files.
D. If all the values that are compared are same, then the Min/Max Amplitude values of both SEGY and ZGY may be extracted. (Block 1040.)
E. Extracted Min/Max Amplitude values may be compared. It may be presumed that the there is no amplitude scaling done at the time of ZGY realization. (Block 1040.)
F. Histograms of amplitude values from each complete dataset may be computed for both SEGY and ZGY and compared. (Block 1050.)
G. Randomly selected IL/XL/Time slices may be generated for both SEGY and ZGY, Min/Max Amplitudes, and Amplitude Histograms may be compared for the randomly selected sections. (Block 1050.) In some example embodiments, the amplitude values of all samples may be compared. In other example embodiments, random (or other scheme) samples may be compared, e.g., for random (or other) selected IL/XL/Z samples.
H. If all of the above steps are satisfied, then the SEGY file may be identified as the source for the ZGY. (Block 1060.)

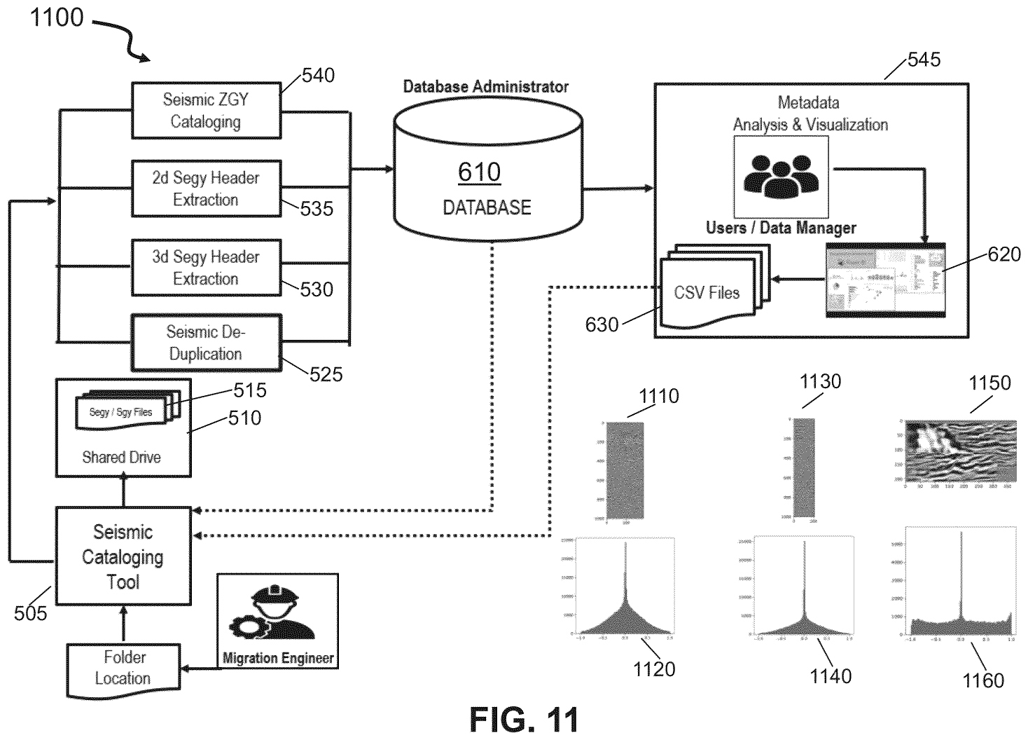

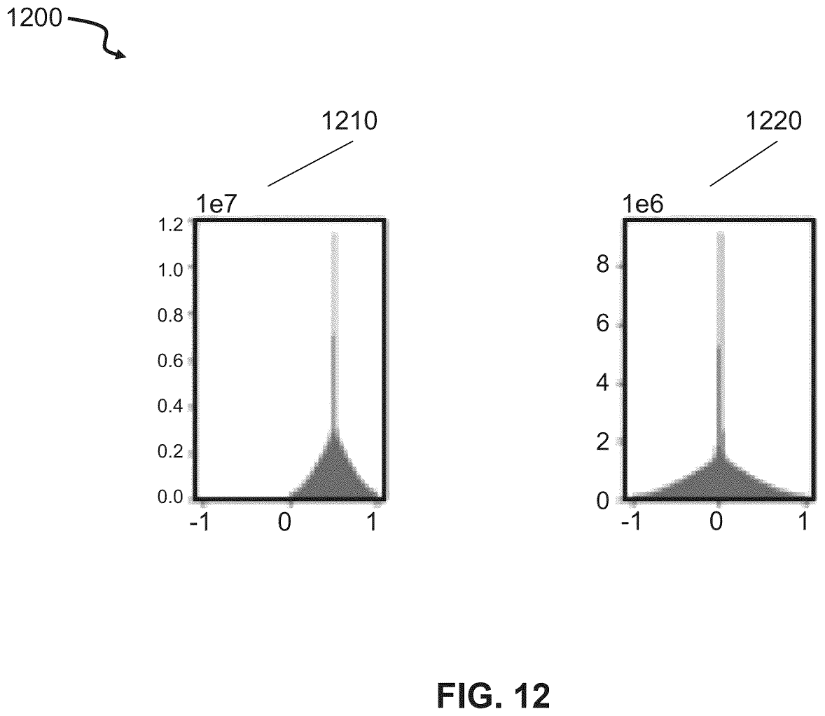

FIG. 11 is a schematic diagram of an example file comparison workflow. FIG. 12 is a set of diagrams showing examples of display patterns and histograms that do not match.

An example of amplitudes being compared programmatically is shown in FIG. 11, which illustrates an example file comparison workflow 1100. Some features of the example file comparison workflow 1100 that repeat features from the example seismic de-duplication workflow 600 of FIG. 6 are omitted for convenience. In the example file comparison workflow 1100, a seismic ZGY cataloging tool 540 (see FIGS. 5 and 6) may take an inline (IL) display pattern 1110 from each of the SEGY and ZGY files being compared, and may generate a corresponding first histogram 1120 for the inline (IL) display pattern 1110 for each of the SEGY and ZGY files being compared, e.g., a first histogram pair. The seismic ZGY cataloging tool 540 may also take a crossline (XL) display pattern 1130 from each of the SEGY and ZGY files being compared, and may generate a corresponding second histogram 1140 for each of the SEGY and ZGY files being compared, e.g., a second histogram pair. The seismic ZGY cataloging tool 540 may also take a time slice display pattern 1150 from each of the SEGY and ZGY files being compared, and may generate a corresponding third histogram 1160 for each of the SEGY and ZGY files being compared, e.g., a second histogram pair. The amplitudes of the first histogram pair may be compared, the amplitudes of the second histogram pair may be compared, and the amplitudes of the third histogram pair may be compared. If the first histogram pair both have the same amplitude, the second histogram pair both have the same amplitude, and the third histogram pair both have the same amplitude, then the SEGY file may be considered to correspond to (e.g., match) the ZGY file. However, if any of the first histogram pair do not have the same amplitude, the second histogram pair do not have the same amplitude, or the third histogram pair do not have the same amplitude, then the SEGY file and the ZGY file do not match, so the ZGY file cannot be used as a representation of the SEGY file, and a new ZGY file should be identified or generated for the SEGY file. FIG. 12 illustrates an example 1200 in which display patterns and histograms do not match. In FIG. 12, a first histogram 1210 was generated from a complete SEGY volume, and a second histogram 1220 was generated from a complete ZGY volume. The histograms 1120, 1140, 1160 for the workflow 1100 of FIG. 11 may be generated based on corresponding samples, e.g., random samples, of the SEGY volume and ZGY volume, or the histograms may be generated based on a complete SEGY volume and a complete ZGY volume. At least the conversion of the display pattern 1110, 1130, 1150 to respective histograms 1120, 1140, 1160 for the comparisons generates a new or improved data structure corresponding to an improvement to a technological process.

### 5—Database and Dashboard

The metadata for each of the SEGY & ZGY format datasets that is extracted through scanning may be pushed to a database (DB), such as POSTGRESQL® DB. Different data views may be created for the database to compare the metadata that is extracted.

One or more dashboards, such as POWER BI® dashboards (or other) dashboards may be prepared, which may read the data from the database, and may have a powerful impact on the user experience. The dashboard(s) may help end users and data managers to discover the data they have in their shared folders, how many of the SEGY & ZGY files are unique and duplicate, their size, location of the files, whether the SEGY file is 2D or 3D, line name, survey name, CRS information if present in the EBCIDIC, metadata extracted from the headers such as IL/XL, SP/CDP, X/Y, Min/Max Amplitude values, Min/Max Z range, Domain, Bin Grid information.

### 6—SEGY2VDS Conversion

In an example embodiment that includes ingesting the Seismic data in a VOLUME DATA STORE™ (VDS) format, an example seismic cataloging solution may help in converting the SEGY files to VDS formats and subsequent ingesting into a cloud based system such as OSDU. The VDS format has been widely used in the industry over 20 years. The process to do so may be as follows.
A. A SEGY2VDS process, e.g., using the Seismic SEGY to VDS conversion tool 550 of FIG. 5, may be an automated solution to convert the Seismic SEGY data to VDS and ingest that to OSDU. The Seismic SEGY to VDS process may be divided into two parts: (1) Metadata migration/ingestion and (2) Seismic bulk data migration/ingestion. Each of these parts may be further divided into three (3) phases, e.g., extract, transform, and ingest. Example details of metadata migration/ingestion and seismic bulk data migration/ingestion are given below.
   i. Metadata Migration/Ingestion: In the extraction phase, the Seismic SEGY to VDS conversion tool 550 may use a seismic cataloging tool to extract metadata information, such as Survey_Geometry_3d, Seismic_2dLine, Seismic_datasets_2d/3d, Acquisition, Seismic File, Header Template etc., from a SEGY file. Extracted metadata may be transformed, mapped, and ingested to corresponding OSDU data types, e.g., Raw Kinds, which may be through an automated script. These data types, e.g., Raw Kinds, may be further mapped to standard record types, e.g., Master, Work Product Component (WPC), and File collection record types, of the OSDU Data Model.
   ii. Seismic Migration/Ingestion: The tool 550 may transform the SEGY files to VDS format, for example, using Bluware Inc. software development kits (SDKs), and may use VDScopy to ingest the converted VDS files to OSDU. Conversion to VDS and ingestion to OSDU may be fully automated, and ingested VDS files and metadata records may be automatically connected.
B. Validation: In any data migration, validation may be an important step. The tool may convert randomly selected VDS files to SEGY, and may compute and compare the checksum values with the input SEGY, which may build the confidence level in data migration. The tool may update a database, e.g., POSTGRESQL® DB, with information, such as the number of SEGY files it scanned, SEGY files converted to VDS, files ingested to OSDU, files that are validated, errors, etc. Interfaces, which may be graphical user interfaces (GUIs), e.g., dashboards, for example, POWER BI® dashboards, may be used to visualize the status of the migration.

### 7—Manifest File Creation

The metadata that is extracted from the SEGY files may be stored in the database, e.g., POSTGRESQL® DB. These may be analyzed and visualized through interfaces, e.g., GUIs, dashboards, or other tools. Manifest files may be created for the metadata, so that they may be ready for ingestion to OSDU.

Multiple files, for example, in JSON formats, may be created, each corresponding to a data type used to describe the seismic datasets, such as Seismic Acquisition Survey, Seismic Bin Grid, Seismic Trace Data, Seismic 3D Interpretation Set, 2D Interpretation Set, Seismic Line Geometry, File Collection OpenZGY, File Collection OpenVDS, File Collection SEGY.

These files, e.g., JAVASCRIPT® Object Notation (JSON) files, may be ingested to a cloud storage platform, e.g., the Open Group Subsurface Data Universe (OSDU®), for example, into RAW Schema definitions. These data types can be considered as a customization or extension to the OSDU data model. They may be used to ensure that all attributes and information are fully captured and preserved, for example, in case some attributes are not yet available in the published OSDU data model.

### 8—Manifest File Ingestion

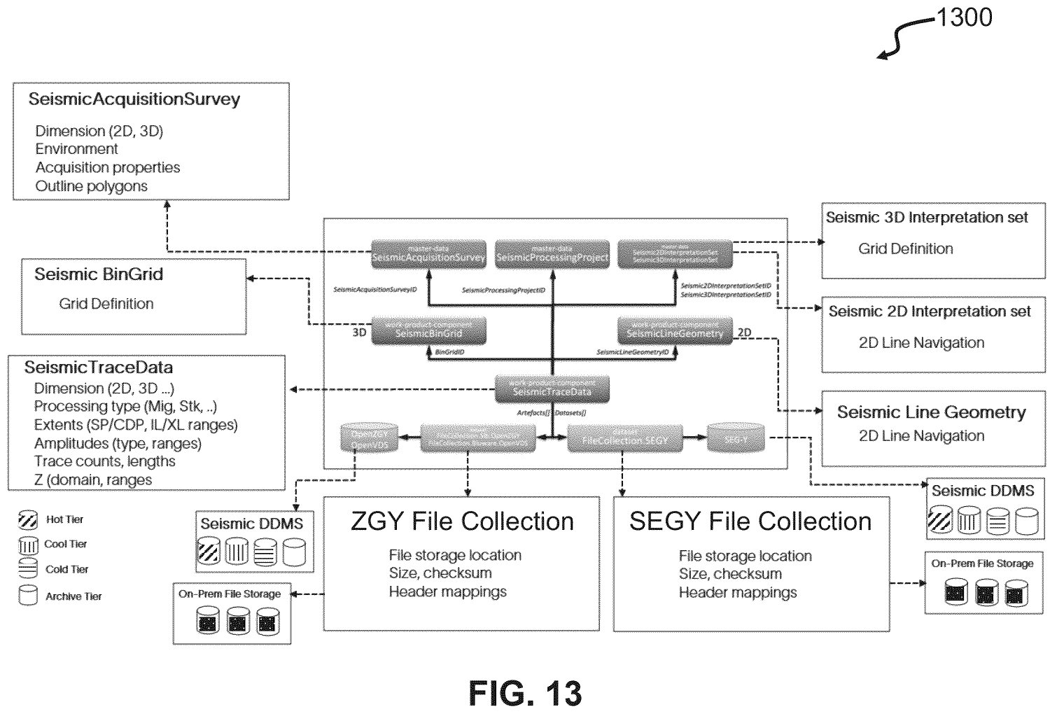

FIG. 13 is a schematic of an example data architecture.

The manifests containing metadata in the raw schema types may be ingested to a cloud storage platform, e.g., OSDU. A mapping from these raw data types to the associated OSDU well-known schema (WKS) data types may be defined. As metadata are ingested into the raw data types, a mapping service manages the creation of related records in the OSDU WKS data types. FIG. 13 shows an overview of an example data architecture 1300 for OSDU WKS data types that may be used to store the extracted metadata.

Table 1 below shows an example of a complete list of metadata that are extracted from SEGY headers and loaded to OSDU in respective Kinds.

TABLE 1

| Seismic Survey/Line | Seismic Dataset | Data File |
|---|---|---|
| Name | Name | Name |
| Description | Description | TotalSize |
| ProjectBeginDate/ | SeismicTraceDataDimensionalityTypeID | FileCollectionPath/ |
| ProjectEndDate | | FileSource (Name) |
| SeismicGeometryTypeID | SeismicDomainTypeID | Checksum |
| SpatialLocation | SeismicAttributeTypeID | SchemaFormatTypeID |
| | SeismicProcessingStageTypeID | EncodingFormatTypeID |
| | SeismicMigrationTypeID | VectorHeaderMapping |
| | SeismicStackingTypeID | |
| | InlineMin/InlineMax/InlineIncrement | |
| | CrosslineMin/CrosslineMax/ | |
| | CrosslineIncrement | |
| | FirstShotPoint/LastShotPoint | |
| | FirstCMP/LastCMP | |
| | SampleInterval | |
| | SampleCount | |
| | StartTime/EndTime | |
| | StartDepth/EndDepth | |
| | TraceCount | |
| | TraceLength | |
| | Precision.WordFormat | |
| | Precision.WordWidth | |
| | LiveTraceOutline | |
| | SpatialArea | |

### 9—Seismic Bulk Data (SEGY/VDS/ZGY) Ingestion to Different Storage Tiers

Seismic bulk data, for example, in any of SEGY, VDS, or ZGY formats, may be ingested to the SDMS on an on-demand basis. The storage locations of the seismic bulk data, e.g., SEGY, VDS, and/or ZGY files, may be stored as an attribute, for example, in POSTGRESQL® and in OSDU. By reviewing the extracted metadata, a user can take an informed decision on which datasets are to be ingested to the SDMS from on-premises storage.

The process for bulk ingestion to the SDMS from the specified location may be automated, with bulk data descriptions ingested as file collection records, which may be used to automatically connect to the records that are generated by ingesting the associated metadata.

In situations in which Storage Tiers are available in the SDMS, the bulk data stored in Hot Tiers can be transferred to alternative tiers, for example, using the available APIs for the same. After transferring the data from Hot Tiers to other tiers, the new location paths may be updated in the OSDU Kinds as needed through available APIs for the same.

The ingested metadata can be viewed, for example, through DataWorkspace (DW), and metadata may be available to search and browse, for example, using a tabular grid view. Geospatial information for 2D lines, and 3D outline polygons, and grids can be visualized, for example, using a DW map view. The information pertaining to a Storage Tier for each bulk dataset, e.g., SEGY, VDS, and/or ZGY files, may be available to review. Depending on the current access requirements for data, users may request that the necessary datasets are transferred into the SDMS, and from there to particular Storage Tiers, such as Cool, Cold, or Archive tiers.

### 10—Alternative Programmatic Extraction

In a standard SEGY file, trace header byte locations for inline (IL), crossline (XL), and surface coordinates (e.g., X-coordinate and Y-coordinate (X/Y)) are fixed. Sometimes, the standard byte locations are not used while writing the seismic data to SEGY, which makes the process of fetching the byte locations of IL, XL, and X/Y from the SEGY trace headers manual and time-consuming.

The process can be automated by programmatically (or algorithmically) extracting the numeric values for all byte locations across all traces and examining the resulting sequence pattern. Inline and crossline numbers tend to change in a structured and grid-like pattern across the 3D volume. For example, crossline increases sequentially trace by trace, while inline remains constant for a group of traces and then moves to the next inline. When graphed, these orderly shifts often create a “step” and “spike” appearance or signature that stands out relative to other header fields.

As different byte locations of trace headers produce a variety of recognizable numeric progressions, we can define a library of pattern archetypes, for example, the eight patterns shown in FIG. 7, that capture behaviors such as steps, sparse spikes, linear, flat/constant runs, or other numeric fields.

Different patterns that one can find from the extracted byte locations for inline/crossline/X-coordinate/Y-coordinate from the trace headers are shown in FIG. 7. Extracted data from the trace header may take any one of the patterns illustrated in FIG. 7.

The extracted values from different byte locations may be compared for the patterns from the above archetypes, based on which one can programmatically (or algorithmically) decide which byte locations are most consistent with IL/XL behavior. If IL/XL byte locations are to be extracted, because IL/XL forms step and spike patterns, these patterns may be identified from the extracted values of all byte locations of trace headers. Once the pattern is identified for each of the byte locations, example embodiments may continue with further analysis to identify X/Y byte locations.

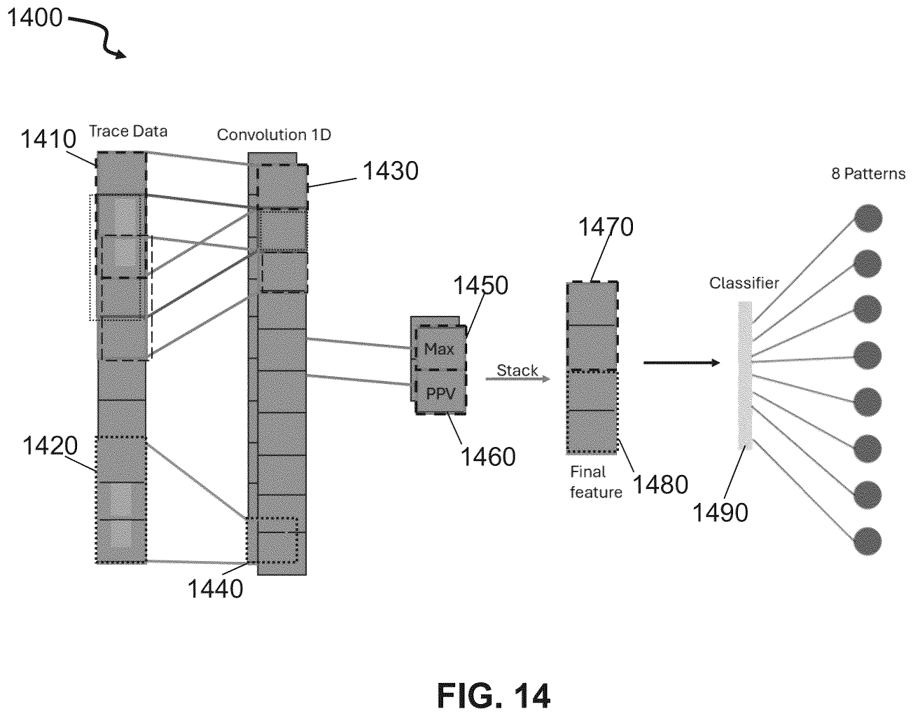

FIG. 14 is a flowchart for an example workflow.

In an example embodiment, a process to automate the pattern recognition step at scale may employ a machine-learning algorithm or model, which may be a Random Convolutional Kernel Transform (ROCKET), which is a fast, state-of-the-art approach for time series (or sequence) data classification. ROCKET may apply a very large set of randomly parameterized one-dimensional (1D) convolutional kernels to each series, and may summarize their responses with lightweight statistics, for example, commonly maximum and proportion of positive values. This produces a high-dimensional but efficiently-computed feature representation that captures the local shapes, such as spikes, and step changes without requiring manual feature engineering. A simple linear classifier (e.g., ridge regression and/or logistic base) trained on these ROCKET features may achieve a strong accuracy across many series data problems, including irregular industrial signals, such as trace header byte streams.

An example ROCKET algorithm may be trained for pre-defined patterns, such as the eight (8) patterns shown in FIG. 7, by using the data extracted from different byte locations of the trace header. Once the model is trained on these pre-defined patterns, the model will be able to predict the patterns from the new and/or unseen data.

For a new SEGY file, values from each byte location of the trace headers may be passed to this trained model, which may predict their pattern. After the patterns are identified for each byte location, the patterns that are similar to the pre-defined patterns, e.g., “Step”, “Spike”, “Inc_coords”, etc. of FIG. 7, may be taken for further analysis to determine the IL/XL or X/Y byte locations.

An example workflow 1400 for ROCKET may operate as follows:
1. ROCKET may generate many random convolutional kernels, e.g., a first kernel 1410 and a second kernel 1420.
2. Each kernel may be convolved with the series of trace data by sliding the kernel across the series (e.g., 1D convolution). FIG. 14 illustrates the first kernel 1410 being slid from a first to a third step in the series of trace data, with each step being shown as a different line type.
3. The convolution operation may involve:
   a. Multiplying the kernel weights with the corresponding series values.
   b. Summing the results to generate a convolution corresponding to the kernel, e.g., a first convolution 1430 denotes the first step of the first kernel 1410, and a second convolution 1440 denotes the final step of the second kernel 1420.
4. After applying each kernel, ROCKET may extract two features (e.g., a first final feature 1470 from the first kernel 1410 and a second final feature 1480 from the second kernel 1420) from the set of convolved outputs for each kernel:
   a. Maximum Value (Max-Pooling or Max) (1450): The maximum value of the convolved output.
   b. Proportion of Positive Values (PPV) (1460): The proportion of values in the convolved output that are greater than zero.
5. Stack: A stack may be made that includes the extracted final features 1470, 1480 of each kernel in sequence.
6. Classification (via a classifier 1490): Based on the extracted features, the data may be classified into any of the pre-determined patterns.

An example ROCKET calculation is shown below:

$$Trace Data$$

$$x = [ 2 , 3 , 1 , 0 , 4 , 5 , 2 , 1 , 3 , 0 ]$$

$$Kernel 1 : [ 1 , - 1 , 2 ]$$

$$Convolution Steps :$$

$$y\_ 1 = 2 * 1 + 3 * - 1 + 1 * 2 = 1$$

$$y\_ 2 = 3 * 1 + 1 * - 1 + 0 * 2 = 2$$

$$y\_ 3 = 1 * 1 + 0 * - 1 + 4 * 2 = 9$$

$$y\_ 4 = 0 * 1 + 4 * - 1 + 5 * 2 = 6$$

$$y\_ 5 = 4 * 1 + 5 * - 1 + 2 * 2 = 3$$

$$y\_ 6 = 5 * 1 + 2 * - 1 + 1 * 2 = 5$$

$$y\_ 7 = 2 * 1 + 1 * - 1 + 3 * 2 = 7$$

$$y\_ 8 = 1 * 1 + 3 * - 1 + 0 * 2 = - 2$$

$$Convolution Result : {y}^{∧} ( 1 ) = [ 1 , 2 , 9 , 6 , 3 , 5 , 7 , - 2 ]$$

$$Max ( {y}^{∧} ( 1 ) ) = 9$$

$$PPV ( {y}^{∧} ( 1 ) ) = 7 / 8 = 0.8 \; 75 ( PPV - Portion of positive values )$$

$$Kernel 2 : [ 0.5 , 0.5 , - 0.5 ]$$

$$Convolution Steps :$$

$$y\_ 1 = 2 * 0.5 + 3 * 0.5 + 1 * - 0.5 = 2.0$$

$$y\_ 2 = 3 * 0.5 + 1 * 0.5 + 0 * - 0.5 = 2.0$$

$$y\_ 3 = 1 * 0.5 + 0 * 0.5 + 4 * - 0.5 = - 1.5$$

$$y\_ 4 = 0 * 0.5 + 4 * 0.5 + 5 * - 0.5 = - 0.5$$

$$y\_ 5 = 4 * 0.5 + 5 * 0.5 + 2 * - 0.5 = 3.5$$

$$y\_ 6 = 5 * 0.5 + 2 * 0.5 + 1 * - 0.5 = 3.$$

$$y\_ 7 = 2 * 0.5 + 1 * 0.5 + 3 * - 0.5 = 0.0$$

$$y\_ 8 = 1 * 0.5 + 3 * 0.5 + 0 * - 0.5 = 2.0$$

$$Convolution Result : {y}^{∧} ( 2 ) = [ 2. , 2. , - 1.5 , - 0.5 , 3.5 , 3. , 0. , 2. ]$$

$$Max ( {y}^{∧} ( 2 ) ) = 3.5$$

$$PPV ( {y}^{∧} ( 2 ) ) = 5 / 8 = 0.625 ( PPV - Portion of positive values )$$

$$Final Feature Vector$$

$$z = [ Max ( {y}^{∧} ( 1 ) ) , PPV ( {y}^{∧} ( 1 ) ) , Max ( {y}^{∧} ( 2 ) ) , PPV ( {y}^{∧} ( 2 ) ) ]$$

$$z = [ 9 , 0.875 , 3.5 , 0.625 ]$$

Then, a classifier may be applied on this feature to identify a final pattern. Once the trace data patterns are identified, then the logic given below may be used to identify the IL, XL, and X/Y. Bytes classified as having a step pattern may be selected as candidate IL bytes. Bytes classified as having a saw-tooth pattern may be selected as candidate XL bytes. A subset of volumes may be considered, and IL and XL may be identified only when below conditions are met, which is similar to the example workflow 800 of FIG. 8 described above:
For every IL, the number of XL remains the same. (See table 810.)
For each step pattern case, if multiple spike patterns are observed, then a closest vector pair is considered. For example, if the IL byte location is “5” with values of {1750, 1751, 1752, 1753, . . . }, and if ROCKET identifies two XL byte locations with a spike pattern, a byte location “17” with values of {3000, 3001, 3002, 3003, . . . } and byte location “1” with values of {1, 2, 3, . . . }, then the closest vector pairs and select byte location “5” and “17” are selected (e.g., via the tool 530 of FIG. 5) as the byte locations for IL and XL.
For each IL case, if multiple XL values satisfy the condition and the values of the multiple byte locations are same, then the closest byte location is considered. For example, if the IL byte location is “185” with values of {1750, 1751, 1752, 1753, . . . }, and ROCKET identifies two XL byte locations with constant non-zero slope value byte location “17” with values of {3000, 3001, 3002, 3003, . . . } and byte location “189” with values of {3000, 3001, 3002, 3003, . . . }, then the closest byte location is selected (e.g., “189” in this example because that number is closer than “17” to the IL byte location of “185”) for XL, and thus byte locations “185” and “189” are selected (e.g., via the tool 530 of FIG. 5) as the byte locations for IL and XL.

For identifying the X/Y byte locations from the trace header, the example workflow 900 of FIG. 9 as described above may be used.

In some example embodiments, any or all of the processes defined above may be completely automated.

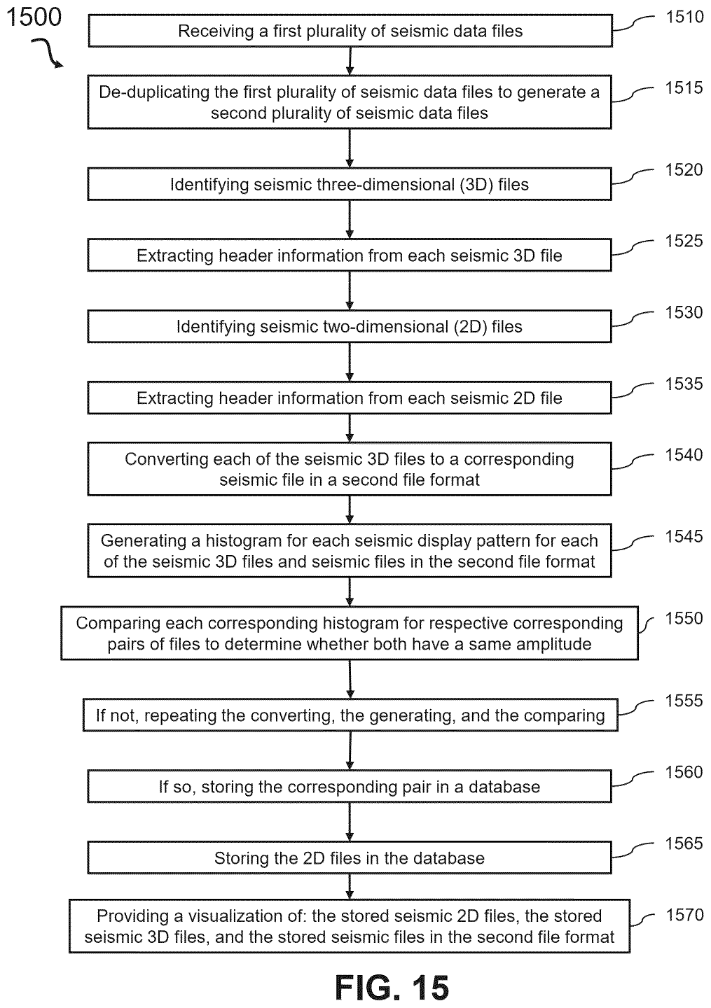

FIG. 15 is a flowchart for an example method.

In FIG. 15, an example method 1500 may include, at 1510, receiving a first plurality of seismic data files in a first file format, each of the first plurality of seismic data files in a first file format comprising a respective seismic display pattern. The example method 1500 may further include, at 1515, de-duplicating the first plurality of seismic data files to generate a second plurality of seismic data files in the first file format that omits duplicate seismic data files. The example method 1500 may further include, at 1520, identifying a plurality of seismic three-dimensional (3D) files in the first file format from among the second plurality of seismic data files in the first file format. The example method 1500 may further include, at 1525, extracting header information from each of the plurality of 3D files in the first file format. The example method 1500 may further include, at 1530, identifying a plurality of seismic two-dimensional (2D) files in the first file format from among the second plurality of seismic data files in the first file format. The example method 1500 may further include, at 1535, extracting header information from each of the plurality of seismic 2D files in the first file format. The example method 1500 may further include, at 1540, converting each of the plurality of seismic 3D files in the first file format to a corresponding plurality of seismic files in the second file format, each of the plurality of seismic files in the second file format comprising a respective seismic display pattern. The example method 1500 may further include, at 1545, generating a corresponding histogram for each respective seismic display pattern for each of the plurality of seismic 3D files in the first file format and the plurality of seismic files in a second file format. The example method 1500 may further include, at 1550, comparing each corresponding histogram for respective corresponding pairs of files among the plurality of seismic 3D files in the first file format and the plurality of seismic files in the second file format to determine whether both of each corresponding pair have a same amplitude. The example method 1500 may further include, at 1555, in response to the comparing determining that both of a given corresponding pair of files does not have a same amplitude, repeating the generating the corresponding histogram for the given corresponding pair of files. The example method 1500 may further include, at 1560, in response to the comparing determining that both of a given corresponding pair of files has a same amplitude, storing the corresponding pair in a database. The example method 1500 may further include, at 1565, storing the plurality of seismic 2D files in the first file format in the database. The example method 1500 may further include, at 1570, providing a visualization of: the stored plurality of seismic 2D files in the first file format, the stored plurality of seismic 3D files in the first file format; and the stored plurality of seismic files in the second file format.

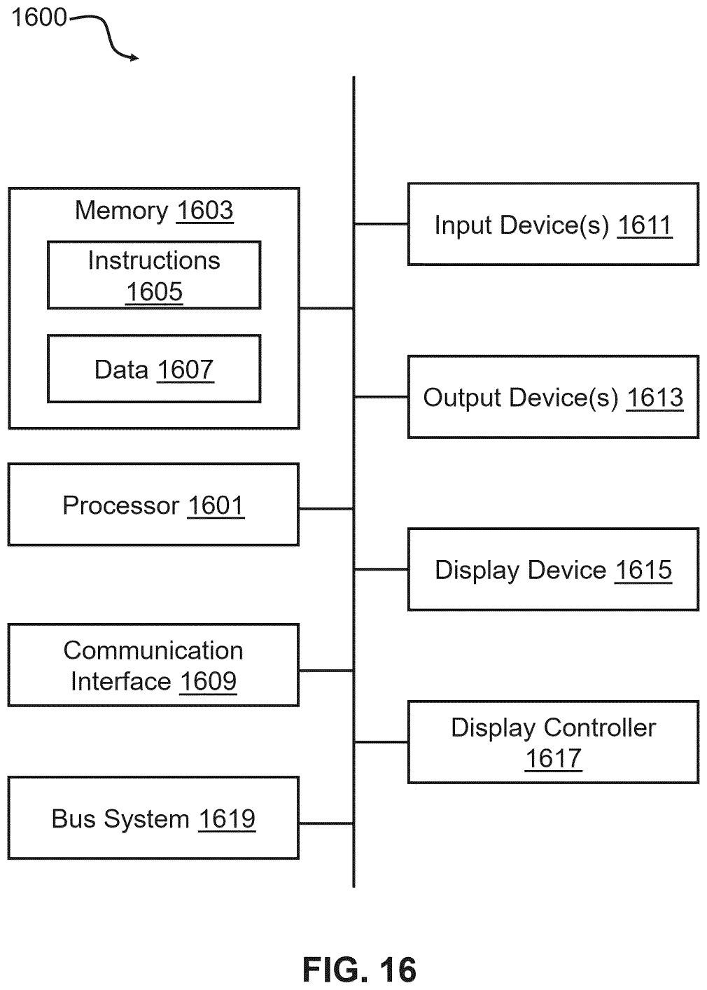

FIG. 16 illustrates certain components that may be included within a computer system according to an example embodiment of the present disclosure.

FIG. 16 illustrates certain components that may be included within a computer system 1600, which may be used to control features according to embodiments of the present disclosure, such as the features discussed with reference to FIGS. 1-14. One or more computer systems 1600 may be used to implement the various devices, components, and systems described herein.

The computer system 1600 includes a processor 1601. The processor 1601 may be a single processor or may include multiple processors and/or sub-processors. The processor 1601 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 1601 may be referred to as a central processing unit (CPU). Although just a single processor 1601 is shown in the computer system 1600 of FIG. 16, in an alternative configuration, a combination of processors (e.g., an ARM and DSP) could be used. In one or more embodiments, the computer system 1600 further includes one or more graphics processing units (GPUs), which can provide processing services related to both entity classification and graph generation.

The computer system 1600 also includes memory 1603 in electronic communication with the processor 1601. The memory 1603 may be any electronic component capable of storing electronic information. For example, the memory 1603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, at least one non-transitory computer-readable and/or processor-readable medium, and so forth, including combinations thereof. The memory may include a single memory devices or multiple memory devices.

Instructions 1605 and data 1607 may be stored in the memory 1603. The instructions 1605 may be executable by the processor 1601 to implement some or all of the functionality disclosed herein. Executing the instructions 1605 may involve the use of the data 1607 that is stored in the memory 1603. Any of the various examples of modules and components described herein may be implemented, partially or wholly, as instructions 1605 stored in memory 1603 and executed by the processor 1601. Any of the various examples of data described herein may be among the data 1607 that is stored in memory 1603 and used during execution of the instructions 1605 by the processor 1601.

A computer system 1600 may also include one or more communication interfaces 1609 for communicating with other electronic devices. The communication interface(s) 1609 may be based on wired communication technology, wireless communication technology, or both. Some examples of communication interfaces 1609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 1600 may also include one or more input devices 1611 and one or more output devices 1613. Some examples of input devices 1611 include a keyboard, mouse, microphone, remote control device, button, joystick, trackball, touchpad, and lightpen. Some examples of output devices 1613 include a speaker and a printer. One specific type of output device that is typically included in a computer system 1600 is a display device 1615. Display devices 1615 used with embodiments disclosed herein may utilize any suitable image projection technology, such as liquid crystal display (LCD), light-emitting diode (LED), gas plasma, electroluminescence, or the like. A display controller 1617 may also be provided, for converting data 1607 stored in the memory 1603 into text, graphics, and/or moving images (as appropriate) shown on the display device 1615.

The various components of the computer system 1600 may be coupled together by one or more buses, which may include a power bus, a control signal bus, a status signal bus, a data bus, etc. For the sake of clarity, the various buses are illustrated in FIG. 16 as a bus system 1619.

The following are sections in accordance with at least one embodiment of the present disclosure:

Clause 1: A method, including: receiving a first plurality of seismic data files in a first file format, each of the first plurality of seismic data files in a first file format including a respective seismic display pattern, de-duplicating the first plurality of seismic data files to generate a second plurality of seismic data files in the first file format that omits duplicate seismic data files, identifying a plurality of seismic three-dimensional (3D) files in the first file format from among the second plurality of seismic data files in the first file format, extracting header information from each of the plurality of seismic 3D files in the first file format, identifying a plurality of seismic two-dimensional (2D) files in the first file format from among the second plurality of seismic data files in the first file format, extracting header information from each of the plurality of seismic 2D files in the first file format, converting each of the plurality of seismic 3D files in the first file format to a corresponding plurality of seismic files in a second file format, each of the plurality of seismic files in the second file format including a respective seismic display pattern, generating a corresponding histogram for each respective seismic display pattern for each of the plurality of seismic 3D files in the first file format and the plurality of seismic files in the second file format, comparing each corresponding histogram for respective corresponding pairs of files among the plurality of seismic 3D files in the first file format and the plurality of seismic files in the second file format to determine whether both of each corresponding pair have a same amplitude, in response to the comparing determining that both of a given corresponding pair of files does not have a same amplitude, repeating the converting, the generating, and the comparing for the given corresponding pair of files, in response to the comparing determining that both of a given corresponding pair of files has a same amplitude, storing the corresponding pair in a database, storing the plurality of seismic 2D files in the first file format in the database, and providing a visualization of: the stored plurality of seismic 2D files in the first file format, the stored plurality of seismic 3D files in the first file format, and the stored plurality of seismic files in the second file format.

Clause 2: The method of clause 1, further including: extracting metadata from the second plurality of seismic data files in the first file format, generating a plurality of seismic manifest files from the metadata, each of the plurality of seismic manifest files corresponding to a respective data type used to describe datasets in the second plurality of seismic data files, ingesting the plurality of seismic manifest files to a cloud storage platform, and ingesting seismic bulk data from to storage tiers, the seismic bulk data including: the stored plurality of seismic 2D files in the first file format, the stored plurality of seismic 3D files in the first file format, and the stored plurality of seismic files in the second file format.

Clause 3: The method of clause 1, wherein the first file format is a SEGY file format.

Clause 4: The method of clause 3, further including, for each of the second plurality of seismic data files in the first file format: extracting an Extended Binary Coded Decimal Interchange Code (EBCDIC) header from the seismic data file, extracting a trace header from the seismic data file, programmatically extracting byte locations for inline (IL)/crossline (XL) and X/Y information from the trace header, the programmatic extracting including: identifying a first selected byte, among a plurality of bytes in the seismic data file, as corresponding to inline (IL) data, the first selected byte having a first byte number, setting the first byte number as the byte location for the IL information from the trace header for the seismic data file, identifying data in the first selected byte, corresponding to IL data, as corresponding to one of a step pattern or a saw-tooth pattern, identifying one or more second selected bytes, among the plurality of bytes in the seismic data file, as corresponding to XL data by determining that data in the one or more second selected bytes corresponds to another of the step pattern or the saw-tooth pattern that is not the one of the step pattern or the saw-tooth pattern of the data in the first selected byte, each of the one or more second selected bytes having a respective second byte number, in response to the one or more second selected bytes being a single byte among the plurality of bytes in the seismic data file corresponding to XL data, setting the second byte number of the single byte as the byte location for the XL information from the trace header for the seismic data file, and in response to there being more than one of the one or more second selected bytes: selecting one of the more than one of the one or more second selected bytes having a second byte number that is closest to the first byte number, and setting the second byte number of the selected one of the more than one of the one or more second selected bytes as byte location for the XL information from the trace header for the seismic data the file, comparing the programmatically extracted byte locations for IL/XL and X/Y information to byte locations for IL/XL and X/Y information in the EBCDIC header to find a difference between the programmatically extracted byte locations for IL/XL and X/Y information and the byte locations for IL/XL and X/Y information in the EBCDIC header, and in response to the comparing finding a difference between the programmatically extracted byte locations for IL/XL and X/Y information and the byte locations for IL/XL and X/Y information in the EBCDIC header, replacing the byte locations for IL/XL and X/Y information in the EBCDIC header with the programmatically extracted byte locations for IL/XL and X/Y information.

Clause 5: The method of clause 4, further including: identifying values in byte locations, among the plurality of bytes in the seismic data file, greater than 10⁵, identifying byte locations having a large jump in the values of particular byte locations of two adjacent traces, and comparing two bytes at a time from among the identified having the large jump in the values of particular byte locations of two adjacent traces, to determine whether: a slope of byte location values selected from the byte locations for the IL information and the XL information from the trace header for the seismic data the file are consistent, and a distance between the two byte locations of adjacent traces from the byte locations for the IL information and the XL information from the trace header for the seismic data the file are consistent.

Clause 6: The method of clause 3, further including, for each of the second plurality of seismic data files in the first file format: extracting an Extended Binary Coded Decimal Interchange Code (EBCDIC) header from the seismic data file, extracting a trace header from the seismic data file, programmatically extracting byte locations for inline (IL)/crossline (XL) and X/Y information from the trace header, the programmatic extracting including: for each byte in the trace header, identifying the data as corresponding to one of a pre-determined set of trace patterns, including: a machine-learning model generating a plurality of random convolutional kernels, each having a respective kernel weight, the machine-learning model convolving each of the plurality of random convolutional kernels with a series of trace data from the trace header by sliding each kernel across the series in groups, the convolving including: multiplying the respective kernel weights with corresponding series values in each group, and summing results of the multiplying for each group, the machine-learning model extracting, from the summed results for each respective kernel, a maximum value and a proportion of values that are greater than zero, the machine-learning model generating a stack by stacking the maximum value and the proportion of values that are greater than zero for each kernel, and the machine-learning model classifying, based on the stack, a pattern of the trace data in the byte as corresponding to one of the pre-determined set of trace patterns, selecting only bytes classified as having a step pattern as candidate IL bytes, selecting only bytes classified as having a saw-tooth pattern as candidate XL bytes, identifying a first selected byte, among the candidate IL bytes, as corresponding to inline (IL) data, the first selected byte having a first byte number, setting the first byte number as the byte location for the IL information from the trace header for the seismic data file, identifying one or more second selected bytes, among the candidate XL bytes, as corresponding to XL data, each of the one or more second selected bytes having a respective second byte number, in response to the one or more second selected bytes being a single byte among the plurality of bytes in the seismic data file corresponding to XL data, setting the second byte number of the single byte as the byte location for the XL information from the trace header for the seismic data file, and in response to there being more than one of the one or more second selected bytes: selecting one of the more than one of the one or more second selected bytes having a second byte number that is closest to the first byte number, and setting the second byte number of the selected one of the more than one of the one or more second selected bytes as byte location for the XL information from the trace header for the seismic data the file, comparing the programmatically extracted byte locations for IL/XL and X/Y information to byte locations for IL/XL and X/Y information in the EBCDIC header to find a difference between the programmatically extracted byte locations for IL/XL and X/Y information and the byte locations for IL/XL and X/Y information in the EBCDIC header, and in response to the comparing finding a difference between the programmatically extracted byte locations for IL/XL and X/Y information and the byte locations for IL/XL and X/Y information in the EBCDIC header, replacing the byte locations for IL/XL and X/Y information in the EBCDIC header with the programmatically extracted byte locations for IL/XL and X/Y information.

Clause 7: The method of clause 6, further including: identifying values in byte locations, among the plurality of bytes in the seismic data file, greater than 10⁵, identifying byte locations having a large jump in the values of particular byte locations of two adjacent traces, and comparing two bytes at a time from among the identified having the large jump in the values of particular byte locations of two adjacent traces, to determine whether: a slope of byte location values selected from the byte locations for the IL information and the XL information from the trace header for the seismic data the file are consistent, and a distance between the two byte locations of adjacent traces from the byte locations for the IL information and the XL information from the trace header for the seismic data the file are consistent.

Clause 8: The method of clause 3, further including: converting the second plurality of seismic data files in the first file format into a third plurality of seismic data files in a third file format, the converting including: metadata migration and ingestion including: extracting metadata information from the second plurality of seismic data files in the first file format, and transforming, mapping, and ingesting the metadata to corresponding data types for a cloud storage platform via an automated script, and seismic bulk data migration and ingestion including: automatically transforming the second plurality of seismic data files in the first file format into the third plurality of seismic data files in a third file format such that the third plurality of seismic data files in a third file format and the metadata information are automatically connected, and automatically ingesting the third plurality of seismic data files in a third file format in the cloud storage platform such that the third plurality of seismic data files in a third file format and the metadata information are automatically connected in the cloud storage platform, and validating the seismic bulk data migration, the validating including computing and comparing checksum values between randomly selected paired files among the second plurality of seismic data files in the first file format and the third plurality of seismic data files in a third file format.

Clause 9: The method of clause 8, wherein: the first file format is a SEGY file format, and the third file format is a Volume Data Store (VDS) file format.

Clause 10: The method of clause 1, wherein the second file format is a ZGY file format.

Clause 11: A system, including: one or more processors, and at least one memory including at least one non-transitory computer-readable medium storing instructions that, when executed by at least one of the one or more processors, cause the system to perform operations, the operations including: receiving a first plurality of seismic data files in a first file format, each of the first plurality of seismic data files in a first file format including a respective seismic display pattern, de-duplicating the first plurality of seismic data files to generate a second plurality of seismic data files in the first file format that omits duplicate seismic data files, identifying a plurality of seismic three-dimensional (3D) files in the first file format from among the second plurality of seismic data files in the first file format, extracting header information from each of the plurality of seismic 3D files in the first file format, identifying a plurality of seismic two-dimensional (2D) files in the first file format from among the second plurality of seismic data files in the first file format, extracting header information from each of the plurality of seismic 2D files in the first file format, converting each of the plurality of seismic 3D files in the first file format to a corresponding plurality of seismic files in a second file format, each of the plurality of seismic files in the second file format including a respective seismic display pattern, generating a corresponding histogram for each respective seismic display pattern for each of the plurality of seismic 3D files in the first file format and the plurality of seismic files in the second file format, comparing each corresponding histogram for respective corresponding pairs of files among the plurality of seismic 3D files in the first file format and the plurality of seismic files in the second file format to determine whether both of each corresponding pair have a same amplitude, in response to the comparing determining that both of a given corresponding pair of files does not have a same amplitude, repeating the converting, the generating, and the comparing for the given corresponding pair of files, in response to the comparing determining that both of a given corresponding pair of files has a same amplitude, storing the corresponding pair in a database, storing the plurality of seismic 2D files in the first file format in the database, and providing a visualization of: the stored plurality of seismic 2D files in the first file format, the stored plurality of seismic 3D files in the first file format, and the stored plurality of seismic files in the second file format.

Clause 12: The system of clause 11, wherein the instructions further include: extracting metadata from the second plurality of seismic data files in the first file format, generating a plurality of seismic manifest files from the metadata, each of the plurality of seismic manifest files corresponding to a respective data type used to describe datasets in the second plurality of seismic data files, ingesting the plurality of seismic manifest files to a cloud storage platform, and ingesting seismic bulk data from to storage tiers, the seismic bulk data including: the stored plurality of seismic 2D files in the first file format, the stored plurality of seismic 3D files in the first file format, and the stored plurality of seismic files in the second file format.

Clause 13: The system of clause 11, wherein the first file format is a SEGY file format.

Clause 14: The system of clause 13, wherein the instructions further include, for each of the second plurality of seismic data files in the first file format: extracting an Extended Binary Coded Decimal Interchange Code (EBCDIC) header from the seismic data file, extracting a trace header from the seismic data file, programmatically extracting byte locations for inline (IL)/crossline (XL) and X/Y information from the trace header, the programmatic extracting including: identifying a first selected byte, among a plurality of bytes in the seismic data file, as corresponding to inline (IL) data, the first selected byte having a first byte number, setting the first byte number as the byte location for the IL information from the trace header for the seismic data file, identifying data in the first selected byte, corresponding to IL data, as corresponding to one of a step pattern or a saw-tooth pattern, identifying one or more second selected bytes, among the plurality of bytes in the seismic data file, as corresponding to XL data by determining that data in the one or more second selected bytes corresponds to another of the step pattern or the saw-tooth pattern that is not the one of the step pattern or the saw-tooth pattern of the data in the first selected byte, each of the one or more second selected bytes having a respective second byte number, in response to the one or more second selected bytes being a single byte among the plurality of bytes in the seismic data file corresponding to XL data, setting the second byte number of the single byte as the byte location for the XL information from the trace header for the seismic data file, and in response to there being more than one of the one or more second selected bytes: selecting one of the more than one of the one or more second selected bytes having a second byte number that is closest to the first byte number, and setting the second byte number of the selected one of the more than one of the one or more second selected bytes as byte location for the XL information from the trace header for the seismic data the file, comparing the programmatically extracted byte locations for IL/XL and X/Y information to byte locations for IL/XL and X/Y information in the EBCDIC header to find a difference between the programmatically extracted byte locations for IL/XL and X/Y information and the byte locations for IL/XL and X/Y information in the EBCDIC header, and in response to the comparing finding a difference between the programmatically extracted byte locations for IL/XL and X/Y information and the byte locations for IL/XL and X/Y information in the EBCDIC header, replacing the byte locations for IL/XL and X/Y information in the EBCDIC header with the programmatically extracted byte locations for IL/XL and X/Y information.

Clause 15: The system of clause 14, wherein the instructions further include: identifying values in byte locations, among the plurality of bytes in the seismic data file, greater than 10⁵, identifying byte locations having a large jump in the values of particular byte locations of two adjacent traces, and comparing two bytes at a time from among the identified having the large jump in the values of particular byte locations of two adjacent traces, to determine whether: a slope of byte location values selected from the byte locations for the IL information and the XL information from the trace header for the seismic data the file are consistent, and a distance between the two byte locations of adjacent traces from the byte locations for the IL information and the XL information from the trace header for the seismic data the file are consistent.

Clause 16: The system of clause 13, wherein the instructions further include, for each of the second plurality of seismic data files in the first file format: extracting an Extended Binary Coded Decimal Interchange Code (EBCDIC) header from the seismic data file, extracting a trace header from the seismic data file, programmatically extracting byte locations for inline (IL)/crossline (XL) and X/Y information from the trace header, the programmatic extracting including: for each byte in the trace header, identifying the data as corresponding to one of a pre-determined set of trace patterns, including: a machine-learning model generating a plurality of random convolutional kernels, each having a respective kernel weight, the machine-learning model convolving each of the plurality of random convolutional kernels with a series of trace data from the trace header by sliding each kernel across the series in groups, the convolving including: multiplying the respective kernel weights with corresponding series values in each group, and summing results of the multiplying for each group, the machine-learning model extracting, from the summed results for each respective kernel, a maximum value and a proportion of values that are greater than zero, the machine-learning model generating a stack by stacking the maximum value and the proportion of values that are greater than zero for each kernel, and the machine-learning model classifying, based on the stack, a pattern of the trace data in the byte as corresponding to one of the pre-determined set of trace patterns, selecting only bytes classified as having a step pattern as candidate IL bytes, selecting only bytes classified as having a saw-tooth pattern as candidate XL bytes, identifying a first selected byte, among the candidate IL bytes, as corresponding to inline (IL) data, the first selected byte having a first byte number, setting the first byte number as the byte location for the IL information from the trace header for the seismic data file, identifying one or more second selected bytes, among the candidate XL bytes, as corresponding to XL data, each of the one or more second selected bytes having a respective second byte number, in response to the one or more second selected bytes being a single byte among the plurality of bytes in the seismic data file corresponding to XL data, setting the second byte number of the single byte as the byte location for the XL information from the trace header for the seismic data file, and in response to there being more than one of the one or more second selected bytes: selecting one of the more than one of the one or more second selected bytes having a second byte number that is closest to the first byte number, and setting the second byte number of the selected one of the more than one of the one or more second selected bytes as byte location for the XL information from the trace header for the seismic data the file, comparing the programmatically extracted byte locations for IL/XL and X/Y information to byte locations for IL/XL and X/Y information in the EBCDIC header to find a difference between the programmatically extracted byte locations for IL/XL and X/Y information and the byte locations for IL/XL and X/Y information in the EBCDIC header, and in response to the comparing finding a difference between the programmatically extracted byte locations for IL/XL and X/Y information and the byte locations for IL/XL and X/Y information in the EBCDIC header, replacing the byte locations for IL/XL and X/Y information in the EBCDIC header with the programmatically extracted byte locations for IL/XL and X/Y information.

Clause 17: The system of clause 16, wherein the instructions further include: identifying values in byte locations, among the plurality of bytes in the seismic data file, greater than 10⁵, identifying byte locations having a large jump in the values of particular byte locations of two adjacent traces, and comparing two bytes at a time from among the identified having the large jump in the values of particular byte locations of two adjacent traces, to determine whether: a slope of byte location values selected from the byte locations for the IL information and the XL information from the trace header for the seismic data the file are consistent, and a distance between the two byte locations of adjacent traces from the byte locations for the IL information and the XL information from the trace header for the seismic data the file are consistent.

Clause 18: The system of clause 13, wherein the instructions further include: converting the second plurality of seismic data files in the first file format into a third plurality of seismic data files in a third file format, the converting including: metadata migration and ingestion including: extracting metadata information from the second plurality of seismic data files in the first file format, and transforming, mapping, and ingesting the metadata to corresponding data types for a cloud storage platform via an automated script, and seismic bulk data migration and ingestion including: automatically transforming the second plurality of seismic data files in the first file format into the third plurality of seismic data files in a third file format such that the third plurality of seismic data files in a third file format and the metadata information are automatically connected, and automatically ingesting the third plurality of seismic data files in a third file format in the cloud storage platform such that the third plurality of seismic data files in a third file format and the metadata information are automatically connected in the cloud storage platform, and validating the seismic bulk data migration, the validating including computing and comparing checksum values between randomly selected paired files among the second plurality of seismic data files in the first file format and the third plurality of seismic data files in a third file format.

Clause 19: The system of clause 18, wherein: the first file format is a SEGY file format, and the third file format is a Volume Data Store (VDS) file format.

Clause 20: The system of clause 11, wherein the second file format is a ZGY file format.

Systems and software, e.g., implemented on a non-transitory computer-readable medium, for performing the methods discussed herein are also within the scope of embodiments of the present disclosure.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims. Any trademarks mentioned herein are the property of their respective owners. Example embodiments are not limited to use of any specific products, services, or trademarked properties mentioned as examples herein.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving a first plurality of seismic data files in a first file format, each of the first plurality of seismic data files in a first file format comprising a respective seismic display pattern;
de-duplicating the first plurality of seismic data files to generate a second plurality of seismic data files in the first file format that omits duplicate seismic data files;
identifying a plurality of seismic three-dimensional (3D) files in the first file format from among the second plurality of seismic data files in the first file format;
extracting header information from each of the plurality of seismic 3D files in the first file format;
identifying a plurality of seismic two-dimensional (2D) files in the first file format from among the second plurality of seismic data files in the first file format;
extracting header information from each of the plurality of seismic 2D files in the first file format;
converting each of the plurality of seismic 3D files in the first file format to a corresponding plurality of seismic files in a second file format, each of the plurality of seismic files in the second file format comprising a respective seismic display pattern;
generating a corresponding histogram for each respective seismic display pattern for each of the plurality of seismic 3D files in the first file format and the plurality of seismic files in the second file format;
comparing each corresponding histogram for respective corresponding pairs of files among the plurality of seismic 3D files in the first file format and the plurality of seismic files in the second file format to determine whether both of each corresponding pair have a same amplitude;
in response to the comparing determining that both of a given corresponding pair of files does not have a same amplitude, repeating the converting, the generating, and the comparing for the given corresponding pair of files;
in response to the comparing determining that both of a given corresponding pair of files has a same amplitude, storing the corresponding pair in a database;
storing the plurality of seismic 2D files in the first file format in the database; and
providing a visualization of:
the stored plurality of seismic 2D files in the first file format;
the stored plurality of seismic 3D files in the first file format; and
the stored plurality of seismic files in the second file format.

2. The method of claim 1, further comprising:
extracting metadata from the second plurality of seismic data files in the first file format;
generating a plurality of seismic manifest files from the metadata, each of the plurality of seismic manifest files corresponding to a respective data type used to describe datasets in the second plurality of seismic data files;
ingesting the plurality of seismic manifest files to a cloud storage platform; and
ingesting seismic bulk data from to storage tiers, the seismic bulk data comprising:
the stored plurality of seismic 2D files in the first file format;
the stored plurality of seismic 3D files in the first file format; and
the stored plurality of seismic files in the second file format.

3. The method of claim 1, wherein the first file format is a SEGY file format.

4. The method of claim 3, further comprising, for each of the second plurality of seismic data files in the first file format:
extracting an Extended Binary Coded Decimal Interchange Code (EBCDIC) header from the seismic data file;
extracting a trace header from the seismic data file;
programmatically extracting byte locations for inline (IL)/crossline (XL) and X/Y information from the trace header, the programmatic extracting comprising:
identifying a first selected byte, among a plurality of bytes in the seismic data file, as corresponding to inline (IL) data, the first selected byte having a first byte number;
setting the first byte number as the byte location for the IL information from the trace header for the seismic data file;
identifying data in the first selected byte, corresponding to IL data, as corresponding to one of a step pattern or a saw-tooth pattern;
identifying one or more second selected bytes, among the plurality of bytes in the seismic data file, as corresponding to XL data by determining that data in the one or more second selected bytes corresponds to another of the step pattern or the saw-tooth pattern that is not the one of the step pattern or the saw-tooth pattern of the data in the first selected byte, each of the one or more second selected bytes having a respective second byte number;
in response to the one or more second selected bytes being a single byte among the plurality of bytes in the seismic data file corresponding to XL data, setting the second byte number of the single byte as the byte location for the XL information from the trace header for the seismic data file; and
in response to there being more than one of the one or more second selected bytes:
selecting one of the more than one of the one or more second selected bytes having a second byte number that is closest to the first byte number; and
setting the second byte number of the selected one of the more than one of the one or more second selected bytes as byte location for the XL information from the trace header for the seismic data the file;
comparing the programmatically extracted byte locations for IL/XL and X/Y information to byte locations for IL/XL and X/Y information in the EBCDIC header to find a difference between the programmatically extracted byte locations for IL/XL and X/Y information and the byte locations for IL/XL and X/Y information in the EBCDIC header; and
in response to the comparing finding a difference between the programmatically extracted byte locations for IL/XL and X/Y information and the byte locations for IL/XL and X/Y information in the EBCDIC header, replacing the byte locations for IL/XL and X/Y information in the EBCDIC header with the programmatically extracted byte locations for IL/XL and X/Y information.

5. The method of claim 4, further comprising:
identifying values in byte locations, among the plurality of bytes in the seismic data file, greater than 10⁵;
identifying byte locations having a large jump in the values of particular byte locations of two adjacent traces; and
comparing two bytes at a time from among the identified having the large jump in the values of particular byte locations of two adjacent traces, to determine whether:
a slope of byte location values selected from the byte locations for the IL information and the XL information from the trace header for the seismic data the file are consistent; and
a distance between the two byte locations of adjacent traces from the byte locations for the IL information and the XL information from the trace header for the seismic data the file are consistent.

6. The method of claim 3, further comprising, for each of the second plurality of seismic data files in the first file format:
extracting an Extended Binary Coded Decimal Interchange Code (EBCDIC) header from the seismic data file;
extracting a trace header from the seismic data file;
programmatically extracting byte locations for inline (IL)/crossline (XL) and X/Y information from the trace header, the programmatic extracting comprising:
for each byte in the trace header, identifying the data as corresponding to one of a pre-determined set of trace patterns, comprising:
a machine-learning model generating a plurality of random convolutional kernels, each having a respective kernel weight;
the machine-learning model convolving each of the plurality of random convolutional kernels with a series of trace data from the trace header by sliding each kernel across the series in groups, the convolving comprising:
multiplying the respective kernel weights with corresponding series values in each group; and
summing results of the multiplying for each group;
the machine-learning model extracting, from the summed results for each respective kernel, a maximum value and a proportion of values that are greater than zero;
the machine-learning model generating a stack by stacking the maximum value and the proportion of values that are greater than zero for each kernel; and
the machine-learning model classifying, based on the stack, a pattern of the trace data in the byte as corresponding to one of the pre-determined set of trace patterns;
selecting only bytes classified as having a step pattern as candidate IL bytes;
selecting only bytes classified as having a saw-tooth pattern as candidate XL bytes;
identifying a first selected byte, among the candidate IL bytes, as corresponding to inline (IL) data, the first selected byte having a first byte number;
setting the first byte number as the byte location for the IL information from the trace header for the seismic data file;
identifying one or more second selected bytes, among the candidate XL bytes, as corresponding to XL data, each of the one or more second selected bytes having a respective second byte number;
in response to the one or more second selected bytes being a single byte among the plurality of bytes in the seismic data file corresponding to XL data, setting the second byte number of the single byte as the byte location for the XL information from the trace header for the seismic data file; and
in response to there being more than one of the one or more second selected bytes:
selecting one of the more than one of the one or more second selected bytes having a second byte number that is closest to the first byte number; and
setting the second byte number of the selected one of the more than one of the one or more second selected bytes as byte location for the XL information from the trace header for the seismic data the file;
comparing the programmatically extracted byte locations for IL/XL and X/Y information to byte locations for IL/XL and X/Y information in the EBCDIC header to find a difference between the programmatically extracted byte locations for IL/XL and X/Y information and the byte locations for IL/XL and X/Y information in the EBCDIC header; and
in response to the comparing finding a difference between the programmatically extracted byte locations for IL/XL and X/Y information and the byte locations for IL/XL and X/Y information in the EBCDIC header, replacing the byte locations for IL/XL and X/Y information in the EBCDIC header with the programmatically extracted byte locations for IL/XL and X/Y information.

7. The method of claim 6, further comprising:
identifying values in byte locations, among the plurality of bytes in the seismic data file, greater than 10⁵;
identifying byte locations having a large jump in the values of particular byte locations of two adjacent traces; and
comparing two bytes at a time from among the identified having the large jump in the values of particular byte locations of two adjacent traces, to determine whether:
a slope of byte location values selected from the byte locations for the IL information and the XL information from the trace header for the seismic data the file are consistent; and
a distance between the two byte locations of adjacent traces from the byte locations for the IL information and the XL information from the trace header for the seismic data the file are consistent.

8. The method of claim 3, further comprising:
converting the second plurality of seismic data files in the first file format into a third plurality of seismic data files in a third file format, the converting comprising:
metadata migration and ingestion comprising:
extracting metadata information from the second plurality of seismic data files in the first file format; and
transforming, mapping, and ingesting the metadata to corresponding data types for a cloud storage platform via an automated script; and
seismic bulk data migration and ingestion comprising:
automatically transforming the second plurality of seismic data files in the first file format into the third plurality of seismic data files in a third file format such that the third plurality of seismic data files in a third file format and the metadata information are automatically connected; and
automatically ingesting the third plurality of seismic data files in a third file format in the cloud storage platform such that the third plurality of seismic data files in a third file format and the metadata information are automatically connected in the cloud storage platform; and
validating the seismic bulk data migration, the validating comprising computing and comparing checksum values between randomly selected paired files among the second plurality of seismic data files in the first file format and the third plurality of seismic data files in a third file format.

9. The method of claim 8, wherein:
the first file format is a SEGY file format; and
the third file format is a Volume Data Store (VDS) file format.

10. The method of claim 1, wherein the second file format is a ZGY file format.

11. A system, comprising:
one or more processors; and
at least one memory comprising at least one non-transitory computer-readable medium storing instructions that, when executed by at least one of the one or more processors, cause the system to perform operations, the operations comprising:
receiving a first plurality of seismic data files in a first file format, each of the first plurality of seismic data files in a first file format comprising a respective seismic display pattern;
de-duplicating the first plurality of seismic data files to generate a second plurality of seismic data files in the first file format that omits duplicate seismic data files;
identifying a plurality of seismic three-dimensional (3D) files in the first file format from among the second plurality of seismic data files in the first file format;
extracting header information from each of the plurality of seismic 3D files in the first file format;
identifying a plurality of seismic two-dimensional (2D) files in the first file format from among the second plurality of seismic data files in the first file format;
extracting header information from each of the plurality of seismic 2D files in the first file format;
converting each of the plurality of seismic 3D files in the first file format to a corresponding plurality of seismic files in a second file format, each of the plurality of seismic files in the second file format comprising a respective seismic display pattern;
generating a corresponding histogram for each respective seismic display pattern for each of the plurality of seismic 3D files in the first file format and the plurality of seismic files in the second file format;
comparing each corresponding histogram for respective corresponding pairs of files among the plurality of seismic 3D files in the first file format and the plurality of seismic files in the second file format to determine whether both of each corresponding pair have a same amplitude;
in response to the comparing determining that both of a given corresponding pair of files does not have a same amplitude, repeating the converting, the generating, and the comparing for the given corresponding pair of files;
in response to the comparing determining that both of a given corresponding pair of files has a same amplitude, storing the corresponding pair in a database;
storing the plurality of seismic 2D files in the first file format in the database; and
providing a visualization of:
the stored plurality of seismic 2D files in the first file format;
the stored plurality of seismic 3D files in the first file format; and
the stored plurality of seismic files in the second file format.

12. The system of claim 11, wherein the instructions further comprise:
extracting metadata from the second plurality of seismic data files in the first file format;
generating a plurality of seismic manifest files from the metadata, each of the plurality of seismic manifest files corresponding to a respective data type used to describe datasets in the second plurality of seismic data files;
ingesting the plurality of seismic manifest files to a cloud storage platform; and
ingesting seismic bulk data from to storage tiers, the seismic bulk data comprising:
the stored plurality of seismic 2D files in the first file format;
the stored plurality of seismic 3D files in the first file format; and
the stored plurality of seismic files in the second file format.

13. The system of claim 11, wherein the first file format is a SEGY file format.

14. The system of claim 13, wherein the instructions further comprise, for each of the second plurality of seismic data files in the first file format:
extracting an Extended Binary Coded Decimal Interchange Code (EBCDIC) header from the seismic data file;
extracting a trace header from the seismic data file;
programmatically extracting byte locations for inline (IL)/crossline (XL) and X/Y information from the trace header, the programmatic extracting comprising:
identifying a first selected byte, among a plurality of bytes in the seismic data file, as corresponding to inline (IL) data, the first selected byte having a first byte number;
setting the first byte number as the byte location for the IL information from the trace header for the seismic data file;
identifying data in the first selected byte, corresponding to IL data, as corresponding to one of a step pattern or a saw-tooth pattern;
identifying one or more second selected bytes, among the plurality of bytes in the seismic data file, as corresponding to XL data by determining that data in the one or more second selected bytes corresponds to another of the step pattern or the saw-tooth pattern that is not the one of the step pattern or the saw-tooth pattern of the data in the first selected byte, each of the one or more second selected bytes having a respective second byte number;
in response to the one or more second selected bytes being a single byte among the plurality of bytes in the seismic data file corresponding to XL data, setting the second byte number of the single byte as the byte location for the XL information from the trace header for the seismic data file; and
in response to there being more than one of the one or more second selected bytes:
selecting one of the more than one of the one or more second selected bytes having a second byte number that is closest to the first byte number; and
setting the second byte number of the selected one of the more than one of the one or more second selected bytes as byte location for the XL information from the trace header for the seismic data the file;
comparing the programmatically extracted byte locations for IL/XL and X/Y information to byte locations for IL/XL and X/Y information in the EBCDIC header to find a difference between the programmatically extracted byte locations for IL/XL and X/Y information and the byte locations for IL/XL and X/Y information in the EBCDIC header; and
in response to the comparing finding a difference between the programmatically extracted byte locations for IL/XL and X/Y information and the byte locations for IL/XL and X/Y information in the EBCDIC header, replacing the byte locations for IL/XL and X/Y information in the EBCDIC header with the programmatically extracted byte locations for IL/XL and X/Y information.

15. The system of claim 14, wherein the instructions further comprise:
identifying values in byte locations, among the plurality of bytes in the seismic data file, greater than 10⁵;
identifying byte locations having a large jump in the values of particular byte locations of two adjacent traces; and
comparing two bytes at a time from among the identified having the large jump in the values of particular byte locations of two adjacent traces, to determine whether:
a slope of byte location values selected from the byte locations for the IL information and the XL information from the trace header for the seismic data the file are consistent; and
a distance between the two byte locations of adjacent traces from the byte locations for the IL information and the XL information from the trace header for the seismic data the file are consistent.

16. The system of claim 13, wherein the instructions further comprise, for each of the second plurality of seismic data files in the first file format:
extracting an Extended Binary Coded Decimal Interchange Code (EBCDIC) header from the seismic data file;
extracting a trace header from the seismic data file;
programmatically extracting byte locations for inline (IL)/crossline (XL) and X/Y information from the trace header, the programmatic extracting comprising:
for each byte in the trace header, identifying the data as corresponding to one of a pre-determined set of trace patterns, comprising:
a machine-learning model generating a plurality of random convolutional kernels, each having a respective kernel weight;
the machine-learning model convolving each of the plurality of random convolutional kernels with a series of trace data from the trace header by sliding each kernel across the series in groups, the convolving comprising:
multiplying the respective kernel weights with corresponding series values in each group; and
summing results of the multiplying for each group;
the machine-learning model extracting, from the summed results for each respective kernel, a maximum value and a proportion of values that are greater than zero;
the machine-learning model generating a stack by stacking the maximum value and the proportion of values that are greater than zero for each kernel; and
the machine-learning model classifying, based on the stack, a pattern of the trace data in the byte as corresponding to one of the pre-determined set of trace patterns;
selecting only bytes classified as having a step pattern as candidate IL bytes;
selecting only bytes classified as having a saw-tooth pattern as candidate XL bytes;
identifying a first selected byte, among the candidate IL bytes, as corresponding to inline (IL) data, the first selected byte having a first byte number;
setting the first byte number as the byte location for the IL information from the trace header for the seismic data file;
identifying one or more second selected bytes, among the candidate XL bytes, as corresponding to XL data, each of the one or more second selected bytes having a respective second byte number;
in response to the one or more second selected bytes being a single byte among the plurality of bytes in the seismic data file corresponding to XL data, setting the second byte number of the single byte as the byte location for the XL information from the trace header for the seismic data file; and
in response to there being more than one of the one or more second selected bytes:
selecting one of the more than one of the one or more second selected bytes having a second byte number that is closest to the first byte number; and
setting the second byte number of the selected one of the more than one of the one or more second selected bytes as byte location for the XL information from the trace header for the seismic data the file;
comparing the programmatically extracted byte locations for IL/XL and X/Y information to byte locations for IL/XL and X/Y information in the EBCDIC header to find a difference between the programmatically extracted byte locations for IL/XL and X/Y information and the byte locations for IL/XL and X/Y information in the EBCDIC header; and
in response to the comparing finding a difference between the programmatically extracted byte locations for IL/XL and X/Y information and the byte locations for IL/XL and X/Y information in the EBCDIC header, replacing the byte locations for IL/XL and X/Y information in the EBCDIC header with the programmatically extracted byte locations for IL/XL and X/Y information.

17. The system of claim 16, wherein the instructions further comprise:
identifying values in byte locations, among the plurality of bytes in the seismic data file, greater than 10⁵;
identifying byte locations having a large jump in the values of particular byte locations of two adjacent traces; and
comparing two bytes at a time from among the identified having the large jump in the values of particular byte locations of two adjacent traces, to determine whether:
a slope of byte location values selected from the byte locations for the IL information and the XL information from the trace header for the seismic data the file are consistent; and
a distance between the two byte locations of adjacent traces from the byte locations for the IL information and the XL information from the trace header for the seismic data the file are consistent.

18. The system of claim 13, wherein the instructions further comprise:
converting the second plurality of seismic data files in the first file format into a third plurality of seismic data files in a third file format, the converting comprising:
metadata migration and ingestion comprising:
extracting metadata information from the second plurality of seismic data files in the first file format; and
transforming, mapping, and ingesting the metadata to corresponding data types for a cloud storage platform via an automated script; and
seismic bulk data migration and ingestion comprising:
automatically transforming the second plurality of seismic data files in the first file format into the third plurality of seismic data files in a third file format such that the third plurality of seismic data files in a third file format and the metadata information are automatically connected; and
automatically ingesting the third plurality of seismic data files in a third file format in the cloud storage platform such that the third plurality of seismic data files in a third file format and the metadata information are automatically connected in the cloud storage platform; and
validating the seismic bulk data migration, the validating comprising computing and comparing checksum values between randomly selected paired files among the second plurality of seismic data files in the first file format and the third plurality of seismic data files in a third file format.

19. The system of claim 18, wherein:
the first file format is a SEGY file format; and
the third file format is a Volume Data Store (VDS) file format.

20. The system of claim 11, wherein the second file format is a ZGY file format.
